(19) United States
(12) Patent Application Publication
(10) Pub. No.: US 2011/0153553 A1
(43) Pub. Date: Jun. 23, 2011

(54) Coordinated Location Aware Brokering of Social Networks

(76) Inventor: Christopher S. Klotz, Ottawa (CA)

(21) Appl. No.: 12/641,502

(22) Filed: Dec. 18, 2009

(51) Int. Cl. G06F 17/30

(52) U.S. Cl. 707/607; 707/E17.01

(57) ABSTRACT

Social networking has become a significant aspect of many people's lives as they communicate with others who are members of the same social networking application. In many instances members who have joined these social networks to find other individuals with similar interests are unaware that people who have these same interests have not joined the same social network but are members of another social network. Today these social networks are discrete, jealously guarding their member profiles, and limiting their member's ability to achieve the goal they joined the social network for. Accordingly, the invention allows members to search and manage activities on multiple social networks through a brokering service, the partner social networks deriving benefit through providing expanded resources to their own members which they do not have to acquire and also from revenue flowing from the brokering service.

### FIELD OF THE INVENTION

This invention relates to mobile social networking and more specifically to providing profile and location based brokering of information within associated social networks.

### BACKGROUND OF THE INVENTION

The Technology, Media and Telecommunications (TMT) business has grown within the past decade through the widespread deployment of wireless devices, personal computers, Internet, and broadband networks which today represent a value chain of over $3 trillion worldwide, including content providers, advertisers, telecommunications companies and electronics suppliers (White Paper Wireless Social Networking from iSuppli, July 2008). Amongst the multiple market segments today for this value chain are applications that are relatively new, rapidly evolving and yet considered to be central and essential to the continued evolution of this value chain. One such segment is so-called “social networking” which focuses on online communities of people who share interests and/or activities, or who are interested in exploring the interests and activities of others (see for example Wikipedia http://en.wikipedia.org/wiki/Social_networking). Social networks are evolving and impacting many activities of users including their family, friends, dating, businesses, Government, medical, and education.

In the next decade wireless social networking products, applications, components, and advertising are anticipated to generate more than $2.5 trillion in revenue by 2020, according to iSuppli (Press Release, Jun. 4, 2008 http://www.isuppli.com/NewsDetail.aspx?ID=12930). Today the demographic penetration of social networking is significantly skewed towards the 18-29 year old range, see Table 1 below, a sector of the population traditionally considered having limited financial resources in respect of hardware, products, components and service plans (see for example Pew's Research Centre for the People and The Press “Internet's Broader Role in Campaign 2008”, Kohut et al, January 2008, http://people-press.org/report/384/internets-broader-role-in-campaign-2008).

TABLE 1
Adult Demographics of Social Networking
Site Usage in the United States (2008)

| | Total % | 18-29% | 30-39% | 40-100% |
|---|---|---|---|---|
| Use social networking sites | 22 | 67 | 21 | 6 |

Expanding these statistics to “absolute” numbers in conjunction with data for teenagers (see for example Pew's Research Centre for the People and The Press “Teens, Privacy and Online Social Networks”, Lenhert and Maddern, April 2007, http://www.pewinternet.org/Reports/2007/Teens-Privacy-and-Online-Social-Networks.aspx) gives an overall snapshot of social networking, as shown in Table 2 below, wherein nearly 75% of social networking users are under 30 years of age.

TABLE 2
Overall Demographics of Social Networking Use in the United States

| | Estimated Number | Percentage of US | Approximate US |
|---|---|---|---|
| Age | of Social Network | Population in Age | Population in Age |
| Range | Users | Range | Range |
| 12-14 | 5,565,000 | 45% | 12,350,000 |
| 15-17 | 8,335,000 | 65% | 13,000,000 |
| 18-29 | 34,250,000 | 67% | 51,100,000 |
| 30-39 | 8,600,000 | 21% | 41,950,000 |
| 40-100 | 8,250,000 | 6% | 137,250,000 |
| TOTAL | 65,000,000 | 25% | 255,650,000 |

During the next decade it is anticipated that mobile devices, such as cellular telephones, smart phones, personal digital assistants (PDA), portable media players, gaming consoles, etc will become the primary channel for either viewing content from, providing content to, or generally accessing the Internet (World Wide Web) for consumers and that social networking will have moved predominantly into the wireless realm providing the degree and type of ubiquitous always available connection that consumers demand. At the same time it is anticipated that this evolution with be accompanied in parallel by both the creation of a new generation of applications that will greatly expand the appeal and utility of social networking, and expansions/evolutions in the functionality of the very wireless devices themselves. In many segments of the social networking industry enterprises will finally generate profits.

It is anticipated that increasingly applications will have to be intuitive to consumers and enabled by innovative technologies, which will be introduced in the timeframe from 2009 to 2015 and accordingly spur the adoption of social networking as a feature of the consumers everyday lives. Today there are essentially three levels of users, these being immediate family and close friends, extended friends, and shared interest groups. Today users interact sporadically, but intensely, with extended friends through games, avatars, and general updates and information. Users with common interests communicate in ways that extend into business albeit with reduced intensity and sporadically. The popularity of social networking in business, for trading, online collaboration, virtual meetings, etc is also likely to significantly spur the advancement of mobile devices and accelerate the cost reduction of these features to the broader consumer base. Such devices will be equipped for improved content viewing, acquisition, sharing and manipulation. Business has recently spurred the adoption of innovative technologies with demonstrated benefits through an ability to support early adoption at price points above those meeting consumer expectations, see for example the penetration of Blackberry™ devices for business at pricing of hundreds of dollars whilst mobile service providers were giving away mobile phones to consumers,

Accordingly, as users move to such wireless devices as their primary means of communicating, accessing content, and using applications in the next decade, the technological innovations will also have to appear within the semiconductor and display industries globally. Increasingly displays will emerge as the most valuable portion of the mobile-device value chain, with makers of portable wireless devices stressing differentiation via superior display technology rather than features which have been important to date including battery lifetime, weight, size, full keyword, etc.

Accordingly display technologies, like touch screens, flexible displays, and motion sensors, will become increasingly important, while demand rises for highly integrated processors that combine numerous high-performance, multi-threaded special purpose cores as consumers expect performance in their wireless devices comparable to the dedicated special purpose processors they exploit today in gaming consoles, wireless devices, and personal computers. Additionally companies that supply the core silicon, microprocessors, graphics accelerators, memory, etc for these wireless social networking devices will increasingly need to balance software and firmware engineers alongside hardware engineers and semiconductor processing specialists.

These trends run against those experienced to date within the social networking arena where the focus has to date been on providing applications and building subscriber numbers and databases for applications where subscribers pay nothing and the enterprises building these hope to make a return from medium to long term strategies of offering enhanced services with fees or introducing advertising for example to generate revenue.

So if we consider a typical hypothetical social networking user of today then we find that they have both a personal computer (PC) and a smart phone, and that whilst their smart phone has a browser and they should be able to access most online sources that they can access from their PC, particularly those with wireless application protocol (WAP). However they do not use their smart phone as a computer, they use their PCs at work/home for anything that is a task requiring more than a couple of minutes or accessing visually intensive data. On the other hand they use their smart phone for short online tasks when on the move, limiting access time due to the subscriber plan they have with their service provider, such as Verizon™, AT&T™, T-Mobile™, BT™ etc. They will extend their access time if they are able to find a free wireless hotspot.

The hypothetical users computer social networking activities are based around writing emails, accessing social network sites such as Facebook™ Hi5™, LinkedIn™, Flickr™, Classmates™, Last™, MySpace™, Twitter™, Windows Live Spaces™, etc, where they read and comment on friends blogs, and upload pictures. A lot of these social networking sites are essentially passive, reading content, clicking here and there. Some social networking websites are more active, where they create and upload content, which will be read and seen by someone else. These social networking applications are however primarily text based and low in audio-visual content. These users also use other application such as Google Talk™, Windows Live Messenger™ and Skype™ for chatting. Their approach to instant messaging (IM) is usually simple: keeping IM turned on (with status online/busy) all the time they are at the computer and have long, informal conversations with whoever is online (one or more people). They will also access other applications such as YouTube™ or dating websites such as LavaLife™, Yahoo Personals™ etc.

Hence, we find that this hypothetical user has mobile phone social networking activities that are very different from those above on the PC. They currently do not translate all their use from their PC to their mobile phone, mainly because the situations they are currently in and because their smart phone has a small screen not suitable for the majority of tasks they perform at the computer. As a result the hypothetical user obviously makes telephone calls, sends texts, and some electronic mail (email) but these emails will be generally shorter than their PC counterparts, and will typically be replies rather than initiating emails or so-called push emails. They download Rich Site Summaries (RSS) with news, use Twitter™ (which limits postings to 140 characters), chat on Yahoo™ Messenger, Blackberry™ Messenger etc and in a limited percentage send direct messages with PIN-to-PIN messaging.

Another characteristic of mobile phone social networking with subscribers, and to a lesser extent computer social networking, is the trend of users rapidly shifting social networking applications and an overall lack of retention from initial use. Even applications such as Facebook™ that work across both computer and mobile environments only achieve a 50% retention rate (Nielsen NetRatings Press Release May 2006, http://www.nielsen-online.com/pr/pr_{—}060511.pdf). Social networking applications such as Twitter™ which are currently causing substantial comments and being discussed as the new Facebook™, YouTube™ etc are only achieving retention rates of 40% (defined in users returning the following month from registering). Despite this each social networking applications (SOCNETAP) today does not share information, as their revenue model is one based upon leveraging their subscriber base and place value on it explicitly. Users must therefore be registered with every SOCNETAP and access it discretely. However, it would be beneficial for a SOCNETAP to allow access to its content from another SOCNETAP as this leverages the value of their subscriber base and provides enhanced functionality to users of these SOCNETAPs. Accordingly, it is an aspect of the invention to facilitate “brokering” of content between SOCNETAPs allowing users to access an increased community of users whilst recompensing the SOCNETAPs according to the degree of content extracted from the alternative SOCNETAPs. Additionally, the provisioning of an increased “brokered” content to the user without requiring them to maintain profiles upon multiple SOCNETAPs and sequentially access each individually should provide the SOCNETAPs with increased user retention.

A common element to a SOCNETAP, such as Facebook™ Hi5™ LinkedIn™ Flickr™, Classmates™, Last™, MySpace™, Twitter™, Windows Live Spaces™ etc is that the subscriber accesses the specific host website associated with that SOCNETAP wherein they have generated a user profile which contains information relating to the subscriber which may include for example, sex, age, name, physical characteristics, likes, dislikes, physical location, email address and a photograph. They typically then generate a user name, which may be their real name, nickname, or a created name, and then a password allowing them to access the website and their personal profile securely. All of this information is today associated with information that has what may be termed “low mobility” such as email address, physical location etc and is hosted by servers associated with the SOCNETAP and according to the specific SOCNETAP may be searched fully or partially by another user of the SOCNETAP who is seeking to find someone they know, have met, or would like to meet. Typically these search type functions are restricted to PC based access as the display functionality of the mobile devices is insufficient for effective use wherein search criteria do not filter the database significantly, as for example searching for a Caucasian (74% of US population), female (50% of US population aged 15-64), aged 35-44 (7% of US population roughly in each 10 year age span starting 25, 35, 45, 55) listing themselves as living in New York (population approximately 19.5 million, http://quickfacts.census.gov/qfd/states/36/36061.html). This represents 2.6% of that 19.5 million, namely approximately 500,000 people.

Accordingly it would be beneficial for the user to be able to include search criteria that of a “higher mobility” without necessarily having access to such confidential information. For example, not every user of a mobile device will have linked their email accounts such that communications sent to say Yahoo™ are routed to the users mobile device but those to their Hotmail™ or Google™ accounts are not, and it is these accounts that are associated for example with their SOCNETAP profiles. As such the information accessed by the user may have aged beyond a useful point in time, i.e. the potential contact was only in New York for a week, or was looking to take them to a Michael Bublé concert at the weekend and they access the account on the Monday. Further, the large search outlined above may be restricted significantly if the search radius is reduced from the typical 10 km, 25 km, 50 km, 100 km, 200 km (which encompasses all of New York in reality) to say 2 km, 1 km, 100 m, 10 m.

As a result such searches return only results local to the user which if performed at late at night in their home may therefore be those living immediately within their neighborhood, or if performed at 7 pm in a bar on 5^{th} Avenue in Manhattan is those they can realistically meet that evening. Such a benefit to the user also proves beneficial to the SOCNETAP provider in that it is a users' satisfaction with the SOCNETAP that ultimately determines the ability of the SOCNETAP to retain its users. Beneficially this also significantly reduces the number of “hits” from the search making it feasible for a user to browse the returned results upon their mobile device. Further a SOCNETAP may derive revenue based upon activities of users who are not registered with them at all but where the user wishes to access their user information.

With many SOCNETAPs such as Facebook™ Hi5™, LinkedIn™, Flickr™, Classmates™, Last™, MySpace™, Twitter™, Windows Live Spaces™ the user will typically only have a single profile as the profiles within these are associated directly with themselves, are generally public, and are used in communicating with their friends, family etc. However, in other applications of a SOCNETAP this may not always be the case. Consider, a user seeking to find a partner for a personal relationship, for example on LavaLife™, Plenty of Fish™, Adult Friend Finder™, then they may establish two or more profiles so that with one profile they present themselves as seeking a long-term relationship but within another are just looking for casual encounters. It would therefore be beneficial to the user if they could manage aspects of the brokering of information between multiple SOCNETAPs simultaneously for each user profile and accordingly reduce time spent swapping personas, generally requiring them to exit, log-back in, and perform a subsequent search.

Additionally it would be beneficial if a user was notified that a matched user within a SOCNETAP also had multiple profiles, as the searching criteria would be performed though information either inaccessible or not offered to the user for a search criteria. In many instances a SOCNETAP does not allow multiple profiles to be lodged with “low mobility” data such as email address but a user using multiple emails addresses may for example be linked through some “high mobility data” such as for example the identity of their mobile device with which they access the SOCNETAP.

It would also be beneficial if the subscriber was able to generate, adapt, and maintain aspects of their “high mobility” data so that for example when the subscriber departs their residence and elects to be active on the SOCNETAP that their profile is up to date and the search results are dynamically adapted accordingly.

Accordingly it is an intention for the invention to provide a SOCNETAP which provides for the brokering of content from a plurality of alternate SOCNETAPs with which the user may or may not be registered. Such a SOCNETAP is beneficial not only to the user of the SOCNETAP in respect of the scope of information accessible, and the alternative ways these information resources may be mined for data, but also to the SOCNETAPs associated with the brokering SOCNETAP in that they may derive revenue from both their existing subscriber base but also from users accessing their databases who are not registered with them. Further, the SOCNETAP provides the means for data mining and display that are more targeted to the users' immediate needs.

### SUMMARY OF THE INVENTION

It is an object of the present invention to obviate or mitigate at least one disadvantage of the prior art.

In accordance with an embodiment of the invention there is provided a method comprising:
(a) providing a brokering service, the brokering service being accessible through the Internet and relating to an activity;
(b) receiving at the brokering service a request from a user, the request being associated with an aspect of the activity;
(c) retrieving from a predetermined subset of a plurality of databases information stored within the predetermined subset of databases, the retrieved information determined in dependence upon at least the request, each database of the plurality of databases being associated with a database source comprising at least one of the brokering service and at least one partner service of a plurality of partner services partnered with the brokering service;
(d) processing the retrieved data in dependence upon an indicator to generate presentation data;
(e) presenting the presentation data to the user;
(f) determining whether a service fee is payable to the database source of at least one partner service of the plurality of partner services, the determination being made in dependence upon at least the request; and
(g) where a service fee is payable to at least one partner service of the plurality of partner services storing an indication of the magnitude of the service fee within a fee database for subsequent use in paying the service fee.

In accordance with an embodiment of the invention there is provided a method comprising:
(a) providing a brokering service, the brokering service being accessible through the Internet and relating to an activity;
(b) receiving at the brokering service a request from a user, the request being associated with an aspect of the activity;
(c) retrieving from a predetermined subset of a plurality of databases information stored within the predetermined subset of databases and determined in dependence upon at least the request, each database of the plurality of databases being associated with a database source comprising at least one of the brokering service and at least one partner service of a plurality of partner services partnered with the brokering service;
(d) filtering the retrieved data in dependence upon a measure of distance between the user and the last known current location of each individual of a plurality of individuals associated with a predetermined portion of the retrieved data;
(e) processing the filtered retrieved data in dependence upon an indicator to generated presentation data;
(f) presenting the presentation data to the user;
(g) determining whether a service fee is payable to the database source of at least one partner service, the determination being made in dependence upon at least the request;
(h) where a service fee is payable to the at least one partner service storing an indication of the magnitude of the service fee within a fee database for subsequent use in paying the service fee;
(i) waiting a predetermined period of time;
(j) establishing a new current location for the user;
(k) establishing a new location for each individual of a plurality of individuals for whom information was retrieved in step (c);
(l) updating the presentation data to include at least one of the new location for each individual or a plurality of new ranges, each new range of the plurality of new ranges being determined in dependence upon at least the new current location of the user and the new location of an individual of the plurality of individuals.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a typical flow for a user of a mobile device according to the prior art with multiple SOCNETAPs to which they are registered;

FIG. 2 depicts a typical flow for a user of a SOCNETAP according to the prior art in registering themselves with the SOCNETAP;

FIG. 3 depicts typical searching flows for a user accessing a dating website upon either a mobile device or a PC;

FIG. 4 depicts typical location based information presentation for a user according to a prior art non-SOCNETAP application;

FIG. 5 depicts an exemplary profile creation for a SOCNETAP according to an embodiment of the invention;

FIG. 6 depicts an exemplary information and revenue flow for a user accessing a SOCNETAP according to an embodiment of the invention at an initial entry level;

FIG. 7 depicts an exemplary information and revenue flow for a user accessing a SOCNETAP according to an embodiment of the invention at a first premium level of service;

FIG. 8 depicts an exemplary information and revenue flow for a user accessing a SOCNETAP according to an embodiment of the invention at another premium level of service;

FIG. 9 depicts an exemplary expansion of information and associated revenue flow for a user accessing a SOCNETAP according to an embodiment of the invention at a premium level of service;

FIG. 10 depicts an exemplary expansion of information presenting multiple profiles associated with another user to a user accessing a SOCNETAP according to an embodiment of the invention at a premium level of service;

FIG. 11 depicts an exemplary expansion of information presenting a comparison of multiple profiles associated with another user to a user accessing a SOCNETAP according to an embodiment of the invention at a premium level of service;

FIG. 12 depicts an exemplary expansion of information presenting profiles based upon location information relative to a user for the user accessing a SOCNETAP according to an embodiment of the invention at a premium level of service;

FIG. 13 depicts an exemplary screen for a user accessing a SOCNETAP according to an embodiment of the invention at a premium level of service wherein the user is presented with matches against their multiple profiles and options to contact them;

FIG. 14 depicts an exemplary expansion of information presenting matching users geographically relative to a user for the user accessing a SOCNETAP according to an embodiment of the invention at a premium level of service; and

FIG. 15 depicts an exemplary information flow for a user accessing a SOCNETAP according to an embodiment of the invention with a premium level of service and managing their user profiles on partner SOCNETAP databases.

### DETAILED DESCRIPTION

The present invention is directed to providing social networking between individuals wherein the initiation of contact is made through wired and/or wireless communications with information extracted from stored databases relating to multiple SOCNETAPs rather than being restricted to a single database associated with a single SOCNETAP.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

In the attached figures the exemplary embodiments with respect to the invention are presented with respect to a SOCNETAP for matchmaking. However, it would be apparent that these embodiments represent exemplary approaches to the brokering of, and expanding presentation of, information, the access provided being dependent upon a service level subscribed to by the user of the SOCNETAP. As such the attached figures and exemplary embodiments present approaches that may be applied to a wide range of SOCNETAPs.

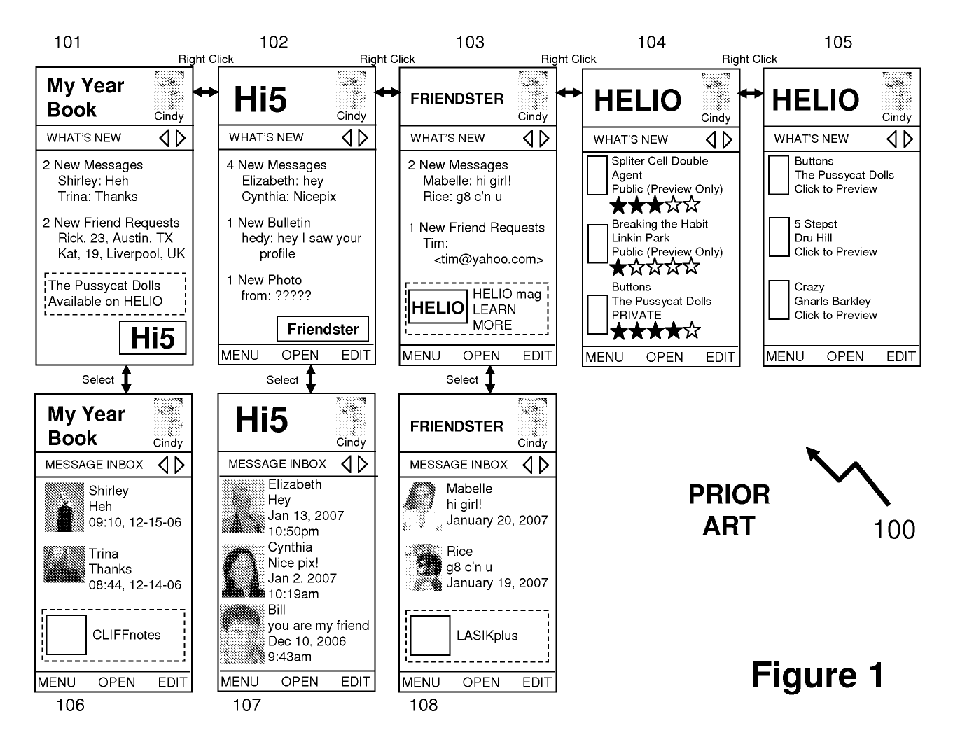

Referring to FIG. 1 there is depicted a typical flow for a user of a mobile device according to the prior art with multiple SOCNETAPs to which they are registered. This exemplary screen flow 100 being representative of commercially deployed systems as of 2009 and presented according to the prior art of T. D. Wugofski et al in US Patent Application 2008/0182563 entitled “Method and System for Social Networking over Mobile Devices Using Profiles”. Exemplary screen flow 100 depicts a method of navigating rapidly between multiple SOCNETAPs, where as with other prior art for SOCNETAPs users generate and maintain profiles within the servers of the company providing the SOCNETAP. Access to the SOCNETAPs on their wireless device is through the wireless network of a telecommunications service provider such as Verizon™, AT&T™, Deutsche Telekom™ etc. Wugofski describes a method wherein the profile within one SOCNETAP embeds links to other SOCNETAPs that the user exploits or employs such that navigation and accessing these is eased against other prior art. Within the prior art previous to Wugofski a user would have to navigate completely out of one SOCNETAP in order to access another SOCNETAP.

Accordingly exemplary screen flow 100 shows a user entering a first SOCNETAP “MyYearBook” (www.myyearbook.com) in first screen 101, and by selecting an icon within first screen 101 and right clicking they move to a second SOCNETAP “Hi5” (www.hi5.com) as shown in second screen 102. This selection in first screen 101 and right click automatically accesses the second SOCNETAP and logs the user in, such that these steps together with logging out of “MyYearBook” are eliminated, thereby speeding and simplifying the user experience. A right click on another icon within “Hi5” then moves the user to third screen 103 and a third social network application “Friendster” where again they are automatically logged into that SOCNETAP. Again in third screen 103 the user scrolls down and selects an icon which with a right click moves them to a fourth SOCNETAP “Helio”, shown in fourth screen 104 (www.helio.com, Helios being acquired in June 2008 by Virgin Mobile). “Helio” as a supplier of high-end smart phones incorporated multiple applications within their devices such as YouTube™ and Flickr™ and employed interfaces geared to such interfaces rather than wireless devices which are geared to other applications and then have the SOCNETAP added subsequently by the user. From fourth screen 104 a right click within “Helio” moves the user from their music downloads to a list of new music.

Alternatively at the first screen 101 if the user elected to view their messages they would move to sixth screen 106 and see their new emails, together with a link at the bottom for “Cliffs Notes” which is a homework and free study guide website for students (www.cliffsnotes.com). Similarly within second screen 102 if the user selected to view their new messages they would be taken to seventh screen 107 and see their new emails, typically with an icon photo of their contact, their name, short title, and a date/time of receipt etc. The same functional movement within their SOCNETAP being shown with movement from third screen 103 for “Friendster” to their email inbox within this SOCNETAP as shown in eighth screen 108.

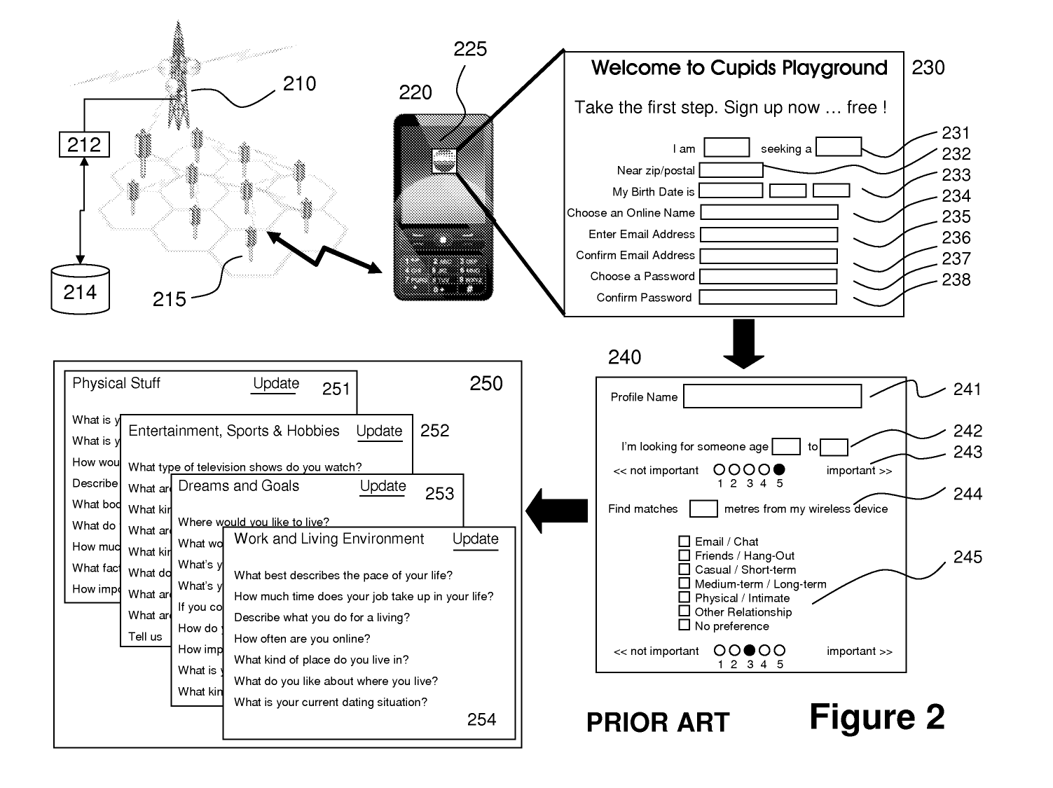

The user of “MyYearBook”, “Hi5”, “Friendster” and “HELIO” in FIG. 1 in order to access their contacts registered with each SOCNETAP would have had to register with each of these SOCNETAPs separately. Referring to FIG. 2 an exemplary display sequence for a user generating a profile with a SOCNETAP is depicted. The user, not shown for clarity, possesses a wireless device 220 and has remotely downloaded a new SOCNETAP “Cupids Playground” from the server 214 of “Cupids Playground Inc” which is connected to the wireless device 220 via telecom network 212 to a base station 210 and a femtocell 215. Having downloaded “Cupids Playground” an icon 225 is displayed upon the wireless device 220. Upon selecting icon 225 the first time the application enters at first screen 230 for the user to generate a profile. As such the user is asked to define in this example if they are a man/woman seeking a man/woman in entry field 231, their residential postal code or another post code that typifies their location in line 232, their date of birth in line 233, to select an online name in line 234, enter an email address in line 235, verify that email address in line 236, choose a password in line 237, and verify that password in line 238.

Having completed first screen 230 the user is then presented with second screen 240 wherein they are prompted to enter additional information including entering a profile title, for example “Looking for Friends to Drink With” in line 241, establish an ideal age range in line 242, attach an importance level to the age range in line 243, specify a radius within which the contacts should live in line 244, and establish one or more types of relationship they are seeking in line 245. From second screen 240 the user may continue to third screen 250, exit and return or perform other options within the SOCNETAP. In progressing to third screen 250 the user is prompted through a series of forms 251 through 254 to enter information regarding themselves which may relate to for example physical in first form 251, entertainment/sports/hobbies in second form 252, dreams and goals in third form 253 and work/living environment 254. This information forming the basis by which “Cupids Playground” establishes a potential match to another user by seeking correlations in activities, interests, etc with respect to sex, age, location etc.

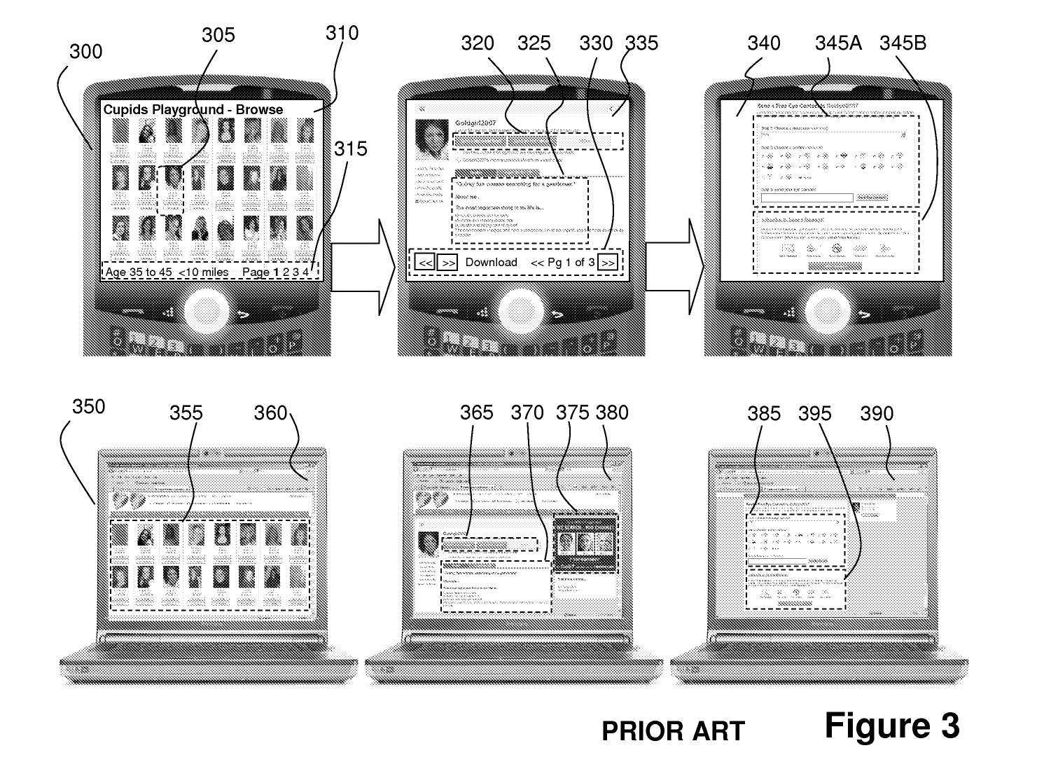

Having generated their user profile the user would now typically continue within the “Cupids Playground” website in order to search for others to meet. Such a search and browsing activity is presented in FIG. 3 according to a typical prior art SOCNETAP with first screen 310 for a user accessing upon a mobile device 300, and fourth screen 360 for a user accessing upon a laptop computer 350. Considering firstly the user on the laptop computer 350 the fourth screen 360 displays a series of photos together with summary information for each such as their username, age, and location, these being within region 355 of the fourth screen 360. If the user selects one returned profile within region 355, or other similar screens as they progress through the returned search results, then the SOCNETAP moves to fifth screen 380, in this example for “GoldGirl2007”, which includes a contact bar 365, profile 370 together with advertisement 380. If the user selects an icon within the contact bar 365 they move to sixth screen 390 wherein they are presented with a first messaging window 385 and a first subscription window 395 providing details of how additional contacting services can be accessed/upgraded through a subscription rather than those available with their free profile.

Now considering the user on their mobile device 300 then it begins with a similar first screen 310 to that of the fourth screen 350 wherein returned search results are presented. Selecting a profile 305 moves the user to second screen 335, which is similar to the fifth screen 380, and contains contact bar 320, profile information 325, and control bar 330. Selecting an icon within contact bar 320 moves the user to third screen 340 wherein they are again presented with a second messaging window 345A and second subscription window 345B. Accordingly it would be evident that the exemplary prior art application, “Cupids Playground” presents the information to the user irrespective of whether the user is accessing via their mobile device 300 or laptop 350. As such the user is able to browse members who have registered with “Cupids Playground” and where a profile is of interest extract additional details and contact them.

It would be apparent to one skilled in the art that the exemplary embodiment depicted within FIG. 3 with the SOCNETAP “Cupids Playground” is equivalent to the prior art applications such as LavaLife™, Plenty of Fish™, Adult Friend Finder™, Facebook™ Hi5™, LinkedIn™, Flickr™, Classmates™, Last™, MySpace™, Twitter™, Windows Live Spaces™, etc that require a user to generate a profile individually within each and only allows the user to search for other users who are registered with each specific SOCNETAP. Hence, for example a registered user of LavaLife™ cannot search profiles of members of Adult Friend Finder™, nor by reverse can the members of Adult Friend Finder™ access profiles of those registered with LavaLife™. Further, whilst some SOCNETAPs are now adopting browser interfaces that adapt the content intended for delivery according to whether the requesting device is a mobile device or a laptop/PC fundamentally the content is not dependent upon the users' device or the users' location. Additionally whilst many SOCNETAPs offer different service levels, such as “Serious”, “Platinum”, etc, these merely change the degree of information provided on or methods of contacting the other users registered with the same SOCNETAP.

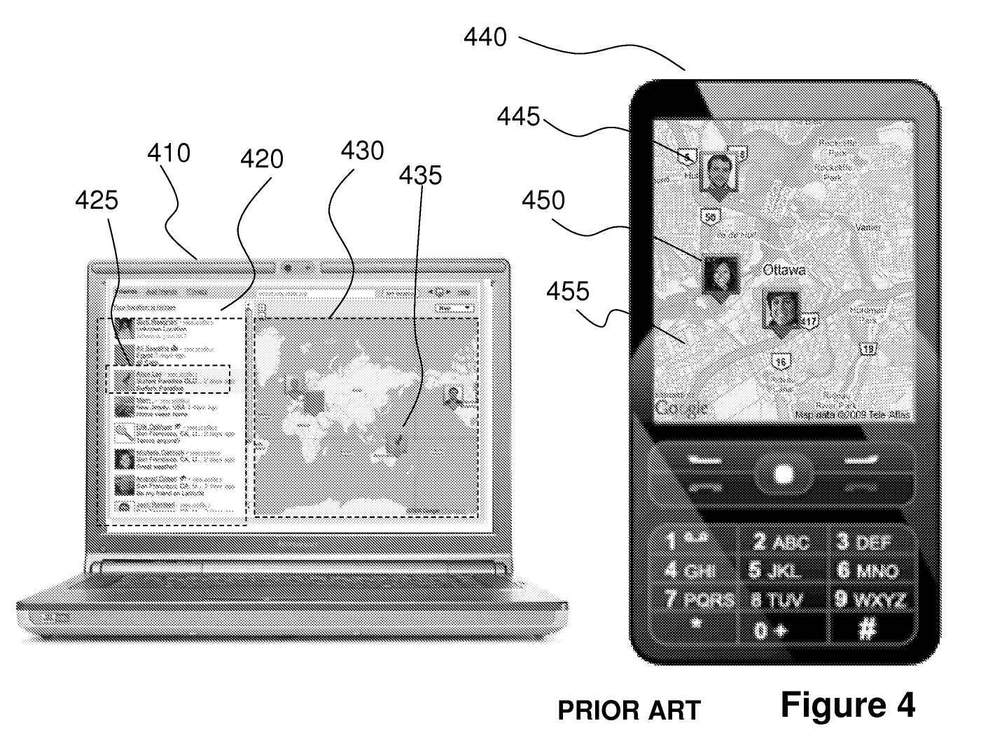

Referring to FIG. 4 there are shown depictions of a geographic location application upon a laptop 410 and mobile device 440, such as Google™ Latitude. The geographic location application in the case of the laptop 410 provides a user with a list of their contacts 420, for example Alice Lee 425 whose location is listed as Surfers Paradise, QLD (Queensland). Also presented to the user is map 430 which displays upon it locations of people who are within their contact list, their list of contacts 420. Accordingly Alice Lee 425 is shown by icon 435 as being in Australia. Similarly a user using the geographic location application on a mobile device 440 is presented with a map 455 upon which are shown first and second icons 445 and 450 representing contacts on the users contact list, not shown as this would be presented in a different display to the user.

The geographic location application is unlike the SOCNETAPs discussed supra in respect of FIGS. 1 to 3 as the contacts for whom geographic location information is presented must be known to the user and registered to the application. In the previous SOCNETAPs the applications provide information about other users who are registered members of the application but do not need to be necessarily known to the user searching, and in many applications such as dating and matchmaking the primary purpose is to provide information relating to others users not known to the user searching the contacts.

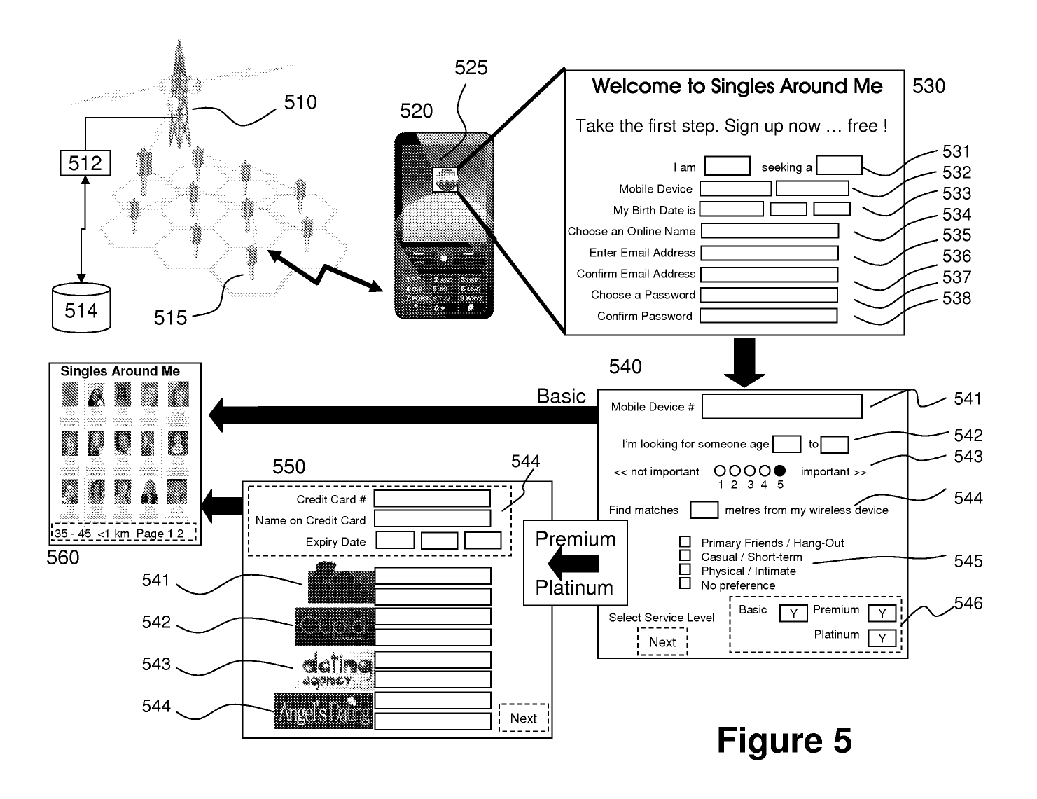

FIG. 5 depicts an exemplary profile creation sequence for a SOCNETAP according to an embodiment of the invention. The user, not shown for clarity, possesses a wireless device 520 and has remotely downloaded a new SOCNETAP SINGLES AROUND ME™ from the server 514 of SINGLES AROUND ME Inc. which is connected to the wireless device 520 via telecom network 512 to a base station 510 and a femtocell 515. Having downloaded SINGLES AROUND ME™ an icon 525 is displayed upon the wireless device 520. Upon selecting icon 525 the first time the application enters at first screen 530 for the user to generate a profile. As such the user is asked to define in this example if they are a man/woman seeking a man/woman in entry field 531, the manufacturer and model number of the mobile device that they will be accessing SINGLES AROUND ME™ with in line 532, their date of birth in line 533, to select an online name in line 534, enter an email address in line 535, verify that email address in line 536, choose a password in line 537, and verify that password in line 538.

Having completed first screen 530 the user is then presented with second screen 540 wherein they enter their mobile device number 541, an age range 542 of the individual they are seeking, an indication 543 of how important matching characteristics are that they define, a distance 544 to find matches within a distance away from their wireless device, select relationship 545 which determines the type of relationship they are seeking, and service level 546 which is available as “Basic”, “Premium” and “Platinum”. If the user has selected the basic service then the SINGLES AROUND ME™ application (SAM) proceeds to display search result screen 560 to the user by presenting images and information relating to individuals matching the users search characteristics.

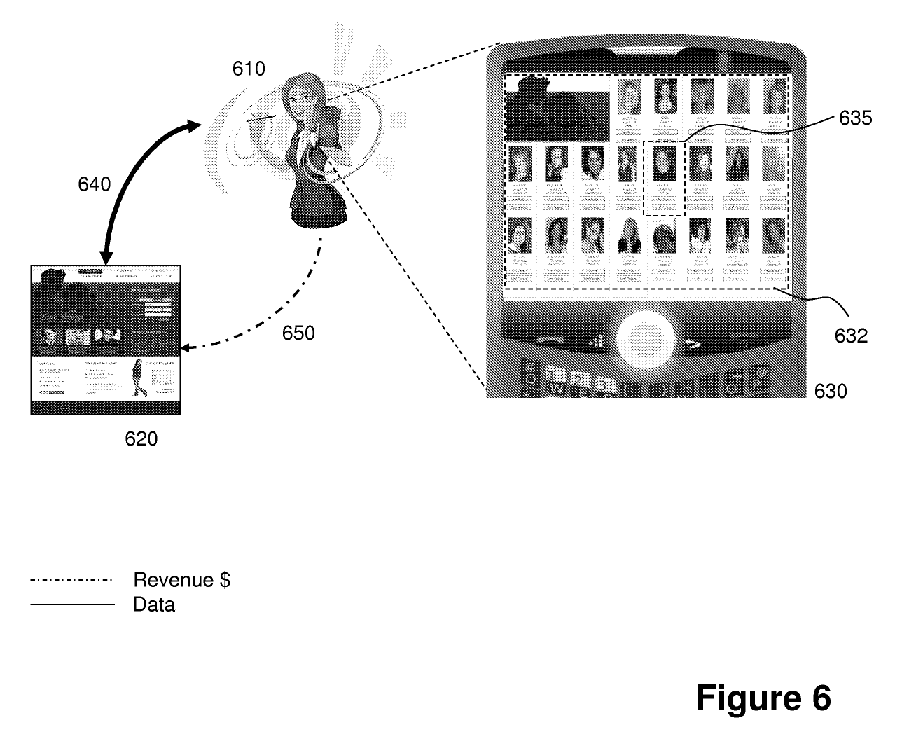

If the user has selected a “Premium” or “Platinum” service level then SINGLES AROUND ME™ moves to a third entry screen 550 wherein they are required to enter payment information 545 for the account, shown as a credit card number, the name on the credit card and it's expiry date. The user is also able at this point to enter any other profiles that they have on SINGLES AROUND ME™ in first profile fields 541, and is also able at this point to enter any profiles that they have created on partner SOCNETAPs to SINGLES AROUND ME™. In this example the user is presented with first partner SOCNETAP “Cupid” 542, second partner SOCNETAP “Dating Agency” 543 and third partner “Angel's Dating” 544. Upon completion of third screen 550 the user is presented with search result screen 560. As will become evident in respect of the embodiments described below in respect to FIGS. 6 through 15 the user registered with SINGLES AROUND ME™ and having “Premium” or “Platinum” services may exploit the partnerships of SINGLES AROUND ME™ to widen the pool of potential contacts and/or manage their multiple profiles through SINGLES AROUND ME™.

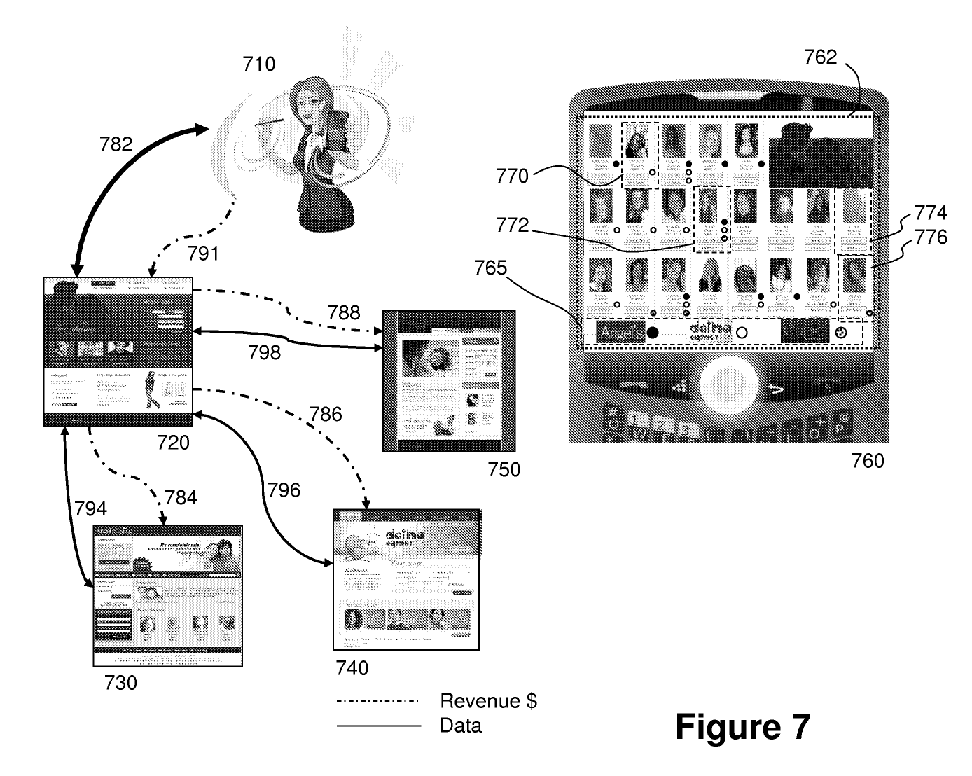

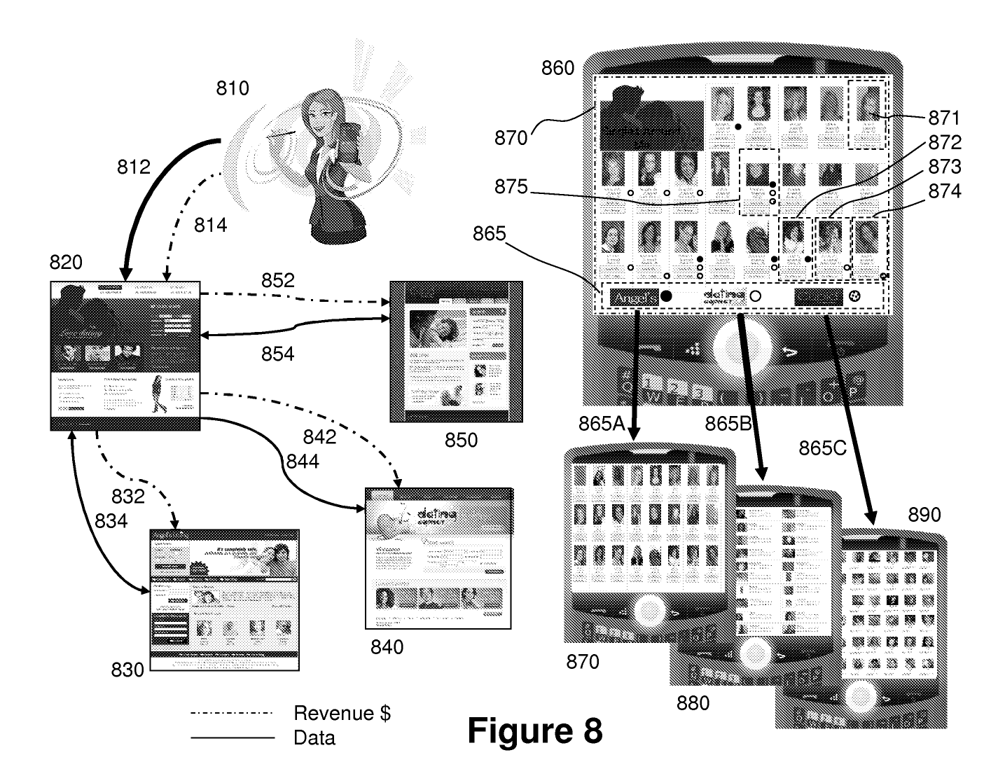

Now referring to FIG. 6 there is depicted an exemplary information and revenue flow for a user accessing a SOCNETAP according to an embodiment of the invention at an initial entry level, such as “Basic” for the SOCNETAP SINGLES AROUND ME™ as described supra in respect of FIG. 5. As shown user 610 is using a wireless device 630 upon which they are accessing SINGLES AROUND ME™ 620 via a telecommunications network, not shown for clarity. The user 610 provides information to SINGLES AROUND ME™ 620 and retrieves information from SINGLES AROUND ME™ 620 relating to activities which include for example searching for other users matching their search criteria, managing their account, messaging users they have established contact with etc. Such an exemplary information flow resulting in search screen 632 upon which the user has selected a profile 635. According to this exemplary embodiment the operating principles of SINGLES AROUND ME™ 620 for a “Basic” member are that the user 610 may perform searches, yielding search screen 632, but retrieving information relating to a selected profile, such as profile 635 requires payment of a fee, denoted by revenue flow 650 within FIG. 6. It would be apparent to one skilled in the art that for users making frequent requests to retrieve profile information etc that upgrading their account to “Premium” or “Platinum” may be more cost effective. However, as noted in FIGS. 7 and 8 below such enhanced service levels provide additional benefits when SINGLES AROUND ME™ 620 operates according to the invention.

Referring to FIG. 7 there is depicted an exemplary information and revenue flow for a user accessing a SOCNETAP according to an embodiment of the invention at a first premium level of service, such as for example “Premium” on the SOCNETAP SINGLES AROUND ME™ as described supra in respect of FIG. 5. As shown user 710 is using a wireless device 760 upon which they are accessing SINGLES AROUND ME™ 720 via a telecommunications network, not shown for clarity. The user 710 provides information to SINGLES AROUND ME™ 720 and retrieves information from SINGLES AROUND ME™ 720 relating to activities which include for example searching for other users matching their search criteria, managing their account, messaging users they have established contact with etc. These being exemplified by first dataflow 782, the provisioning of these services having been provided by their selection of a “Premium” service level and payment of their subscriber payment 791 to SINGLES AROUND ME™ 720.

Within FIG. 7 the first dataflow 782 results in display screen 762 that presents profiles to the user 710 matching their search criteria. Now in display screen 762 unlike the instance described supra in respect of display screen 632 of FIG. 6 supra for a subscriber at a “Basic” service level the display screen 762 contains profiles not only from SINGLES AROUND ME™ 720 but also from partner SOCNETAPs of SINGLES AROUND ME™ 720. These partner SOCNETAPs being shown on display screen 762 in window 765 and being “Angel's” 730, “Dating Agency” 740 and “Cupid” 750. The information provided by the user 710 to SINGLES AROUND ME™ 720 in first dataflow 782 is parsed by SINGLES AROUND ME™ 720 into second dataflow 794 which is provided to “Angel's” 730, third dataflow 796 to “Dating Agency” 740, and fourth dataflow 798 to “Cupid” 750. Each of these partner SOCNETAPs returning profile data relating to users of these partner SOCNETAPs that matches the search criteria of user 710.

The display screen therefore shows profiles which may be only registered with SINGLES AROUND ME™ 720, for example “Shortnsweet” 774, registered with one partner SOCNETAP such as “Loulou3” 770 and “Sweet265” 776 for example, or with multiple partner SOCNETAPs such as “Justlooking” 772 for example. Selection of one of these profiles associated with a user profile on a partner SOCNETAP results in a revenue flow from SINGLES AROUND ME™ 720 to the partner SOCNETAPs, “Angel's” 730, “Dating Agency” 740 and “Cupid” 750, as shown by first through third revenue flows 784, 786, and 788 respectively. For example “Angel's” 730 would receive revenue via first revenue flow 784 for selection of “Loulou3” 772, “Dating Agency” 740 would receive revenue via second revenue flow 786 for selection of either “Shortnsweet” 770 and “Loulou3” 772, and “Cupid” 760 would receive revenue via third revenue flow 788 for selection of “Sweet265” 776. Selection of “Justlooking” 774 does not trigger revenue flow to any of the partner SOCNETAPs as they are only registered with SINGLES AROUND ME™ 720.

Accordingly the user 710 by selecting the “Premium” service on SOCNETAP SINGLES AROUND ME™ 720 is able to search and retrieve profiles for users on the partner SOCNETAPs, “Angel's” 730, “Dating Agency” 740 and “Cupid” 750, in addition to those on SINGLES AROUND ME™ 720. In this manner the user 720 has a significantly expanded base of potential matches to search and select from. It would also be evident that the partnership relationship between SINGLES AROUND ME™ 720 and “Angel's” 730, “Dating Agency” 740 and “Cupid” 750 has benefits to these SOCNETAPs also. For example, SINGLES AROUND ME™ 720 is able to provide significant profiles to a user 710 even when it itself may have very few due to being a new SOCNETAP, have geographical fluctuations in its member base, or other factors limiting its database of profiles for example. Additionally the partner SOCNETAPs, “Angel's” 730, “Dating Agency” 740 and “Cupid” 750, derive benefit in that users of SINGLES AROUND ME™ 720 who may not be registered with a particular SOCNETAP are able to search their profiles online and the partner SOCNETAP derives revenue when the user 710 retrieves a profile.

It would be evident to one skilled in the art that the revenue flows in FIG. 7 supra from the SINGLES AROUND ME™ 720 to “Angel's” 730, “Dating Agency” 740 and “Cupid” 750 were triggered by a user retrieving detailed profiles from the partner SOCNETAP websites. It would be evident that where a user such as “Loulou3” is present on multiple SOCNETAPs that some revenue sharing may be applied to the multiple SOCNETAPs that “Loulou3” 772 is registered with or that the user 710 may select one of the three SOCNETAPs to have the detailed profile retrieved from. It would also be evident that the revenue may be triggered based upon other events other than retrieving a detailed profile, such as the initiation of communication between the user 710 and the selected profile, or be based upon the method of communication between the two users, for example a simple “Hi” in an automated message might not trigger a revenue flow but a user generated message may not. Alternatively, whilst the revenue flows have been shown as originating with SINGLES AROUND ME™ 720 they may alternatively be in the opposite direction. For example, a user on “Cupid” 750 sees that the user 710 has browsed and retrieved their profile but not contacted them, this user on “Cupid” 750 looks at the user 710 profile on SINGLES AROUND ME™ 720 and decides to contact them. In this scenario the arrangement between SINGLES AROUND ME™ 720 and the partner SOCNETAPs might provide for the revenue flow to be from “Cupid” 750 to SINGLES AROUND ME™ 720.

It would be apparent to one skilled in the art that the revenue flows discussed supra in respect of FIG. 7 may be ones that are established upon a scale that varies according to predetermined factors that may include for example the degree of information retrieved, the method of contact, the extent of communications, whether one or other user opens an otherwise private area of information (such as additional photographs, text, etc), etc.

Referring to FIG. 8 there is depicted an exemplary information and revenue flow for a user accessing a SOCNETAP according to an embodiment of the invention at a second premium level of service, such as for example “Platinum” on the SOCNETAP SINGLES AROUND ME™ as described supra in respect of FIG. 5. As shown user 810 is using a wireless device 860 upon which they are accessing SINGLES AROUND ME™ 820 via a telecommunications network, not shown for clarity. The user 810 provides information to SINGLES AROUND ME™ 820 and retrieves information from SINGLES AROUND ME™ 820 relating to activities which include for example searching for other users matching their search criteria, managing their account, messaging users they have established contact with etc. These being exemplified by first dataflow 812, the provisioning of these services having been provided by their selection of a “Platinum” service level and payment of their subscriber payment 814 to SINGLES AROUND ME™ 820.

Within FIG. 8 the first dataflow 812 results in display screen 870 that presents profiles to the user 810 matching their search criteria. Display screen 870, unlike the instance described supra in respect of display screen 632 of FIG. 6 supra for a subscriber at a “Basic” service level but like display screen 762 of FIG. 7 supra for a subscriber at a “Premium” service level, displays profiles that relate to registered users not only from SINGLES AROUND ME™ 820 itself but also from its partner SOCNETAPs. These partner SOCNETAPs being shown on display screen 870 in window 865 and being “Angel's” 830, “Dating Agency” 840 and “Cupid” 850. The information provided by the user 810 to SINGLES AROUND ME™ 820 in first dataflow 812 is parsed by SINGLES AROUND ME™ 820 into second dataflow 834 which is provided to “Angel's” 830, third dataflow 844 to “Dating Agency” 840, and fourth dataflow 854 to “Cupid” 850. Each of these partner SOCNETAPs returning profile data relating to users of these partner SOCNETAPs that matches the search criteria of user 810.

The display screen therefore shows profiles which may be only registered with SINGLES AROUND ME 720, for example “Winnie-2” 871, registered with one partner SOCNETAP such as “Lisa3756” 872 with “Angel's 830, “Snoopy-2000” 873 with “Dating Agency” 840, and “Sweet265” 874 with “Cupid” 850 for example, or with multiple partner SOCNETAPs such as “FreeAtLast” 875 for example. Selection of one of these profiles associated with a user profile on a partner SOCNETAP results in a revenue flow from SINGLES AROUND ME™ 820 to the partner SOCNETAPs, “Angel's” 830, “Dating Agency” 840 and “Cupid” 850, as shown by first through third revenue flows 832, 842, and 852 respectively. For example “Angel's” 830 would receive revenue via first revenue flow 832 for selection of “Lisa3756” 872, “Dating Agency” 840 would receive revenue via second revenue flow 842 for selection of “Snoopy-2000” 873, and “Cupid” 850 would receive revenue via third revenue flow 852 for selection of “Sweet265” 874. Selection of “Winnie-2” 871 does not trigger revenue flow to any of the partner SOCNETAPs as they are only registered with SINGLES AROUND ME™ 820.

In addition to the retrieved search results presented in display screen 870, that combines the results from SINGLES AROUND ME™ 820 and the partner SOCNETAPs, user 810 is able to search each of the partner SOCNETAPs discreetly. For example, selecting the icon for “Angel's” 830 within the window 865 then via first flow 865A the user 810 is presented with second display screen 870 which is only users registered with “Angel's” 830. Selecting the icon for “Dating Agency” 840 in window 865 triggers flow second flow 865B wherein the user is presented with third display screen 880 with only users registered with “Dating Agency” 840, and similarly selecting the icon for “Cupid” 850 in window 865 triggers flow second flow 865C wherein the user is presented with third display screen 890 with only users registered with “Cupid” 850.

Accordingly the user 810 by selecting the “Platinum” service on SOCNETAP SINGLES AROUND ME™ 820 is able to search and retrieve profiles for users on the partner SOCNETAPs, “Angel's” 830, “Dating Agency” 840 and “Cupid” 850, in addition to those on SINGLES AROUND ME™ 820. These searches may be specific to one SOCNETAP or may merge results from them all. In this manner the user 810 has a significantly expanded base of potential matches to search and select from. It would also be evident that the partnership relationship between SINGLES AROUND ME™ 820 and “Angel's” 830, “Dating Agency” 840 and “Cupid” 850 has benefits to these SOCNETAPs also as discussed supra in respect of FIG. 7.

It would be evident to one skilled in the art that the revenue flows in FIG. 8 supra from the SINGLES AROUND ME™ 820 to “Angel's” 830, “Dating Agency” 840 and “Cupid” 850 were triggered by a the user retrieving detailed profiles from the partner SOCNETAP websites. It would be evident that where a user such as “FreeAtLast” 875 is present on multiple SOCNETAPs that some revenue sharing may be applied to the multiple SOCNETAPs that “FreeAtLast” 875 is registered with or that the user 810 may select one of the three SOCNETAPs to have the detailed profile retrieved from. Optionally, the revenue may be determined for example if the profile is retrieved from a search of all partner SOCNETAPs as well as SINGLES AROUND ME™ 820 or a specific search of one partner SOCNETAP. It would also be evident that the revenue may be triggered based upon other events other than retrieving a detailed profile, such as the initiation of communication between the user 820 and the member associated with the selected profile, or be based upon the method of communication between the two users, for example a simple “Hi” in an automated message might not trigger a revenue flow but a user generated message may not. Alternatively, whilst the revenue flows have been shown as originating with SINGLES AROUND ME™ 820 they may alternatively be in the opposite direction. For example, a user on “Cupid” 850 sees that the user 810 has browsed and retrieved their profile but not contacted them, this user on “Cupid”850 looks at the user 810 profile on SINGLES AROUND ME™ 820 and decides to contact them. In this scenario, the arrangement between SINGLES AROUND ME™ 820 and the partner SOCNETAPs might provide for the revenue flow to be from “Cupid” 850 to SINGLES AROUND ME™ 820.

It would be apparent to one skilled in the art that the revenue flows discussed supra in respect of FIG. 8 may be ones that are established upon a scale that varies according to predetermined factors that may include for example the degree of information retrieved, the method of contact, the extent of communications, whether one or other user opens an otherwise private area of information (such as additional photographs, text, etc), etc. Optionally the user 810 having established themselves at a “Platinum” service level, rather than “Basic” as presented supra in respect of an exemplary embodiment in FIG. 6, or “Premium” as presented supra in respect of an exemplary embodiment in FIG. 7, has access to additional services or features which are not offered to those at these other services levels. For example, it was discussed supra that a member profile might have public and private areas, the latter of which would not be accessible to the user unless the member allowed. Such a concept might be expanded to that where there is a first summary public profile, a second detailed public profile, and a private profile. As such the user with a “Platinum” service level would have access to the first and second public profiles unlike those at “Basic” and “Premium”.

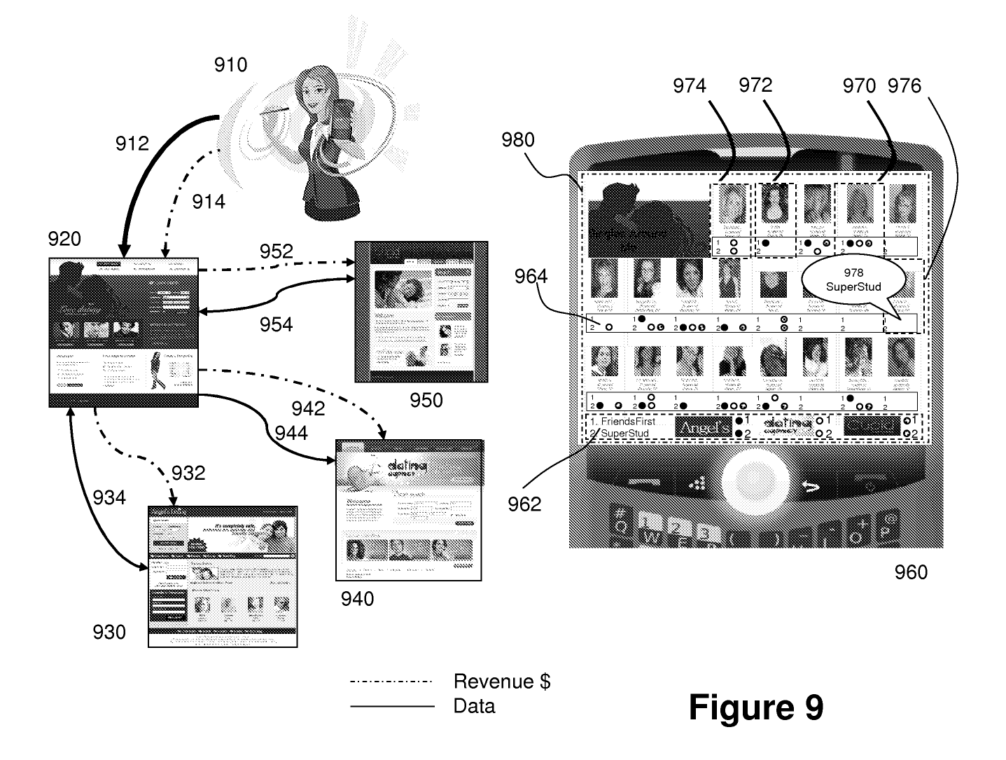

In respect of additional services or features available to those with increased service level as discussed supra in respect of FIGS. 6 through 8 then FIG. 9 depicts an exemplary expansion of the information and associated revenue flow for a user wherein the user is not only retrieving brokered profiles from SINGLES AROUND ME™ and it's partner SOCNETAPs but this information is presented with respect to multiple profiles associated with the user.

Accordingly, in FIG. 9 a user 910 is shown employing a mobile device 960 upon which they are accessing SINGLES AROUND ME™ 920 via a telecommunications network, not shown for clarity. The user 910 provides information to SINGLES AROUND ME™ 920 and retrieves information from SINGLES AROUND ME™ 920 relating to activities which include for example searching for other users matching their search criteria, managing their account, messaging users they have established contact with etc. These being exemplified by first dataflow 912, the provisioning of these services having been provided by their selection of a “Platinum” service level for example and payment of their subscriber payment 914 to SINGLES AROUND ME™ 920. SINGLES AROUND ME™ 920 in performing the required service to user 910 parses the search information contained within the first dataflow 912 and provides this to the partner SOCNETAPs, via second dataflow 934 to “Angel's” 930, third dataflow 944 to “Dating Agency” 940, and fourth dataflow 954 to “Cupid” 950.

The resulting second to fourth dataflows 934, 944, and 954 providing information to SINGLES AROUND ME™ 920 allowing it to display a display screen 980 to user 910. At the bottom of display 980 is information bar 962 that presents the partner SOCNETAPs, “Angel's” 930, “Dating Agency” 940, and “Cupid” 950 together with marker identifiers (not identified explicitly) which are labeled numerically to match two profiles of the user 910 on SINGLES AROUND ME™ 920, namely “FriendsFirst” and “SuperStud”. The display screen 980 thereby presents profiles to the user 910 with information relating to the partner SOCNETAP and the user profile. Accordingly, “Cupid Calling” 970 is shown having a profile on each of “Angel's” 930, “Dating Agency” 940, and “Cupid” 950 that matches “FriendsFirst”, “Nikitita” 972 is shown having a profile on “Angel's” 930 that matches “FriendsFirst”, “BlueIsland” 974 is shown having a profile only on “Dating Agency” 940 that matches both “FriendsFirst” and “SuperStud”, whilst “JustLooking” 976 is shown to have no matching profiles on any of “Angel's” 930, “Dating Agency” 940, and “Cupid” 950. If the user 910 selected “JustLooking” 976 then an icon 978 pops up identifying “JustLooking” 976 as matching their “SuperStud” profile.

As discussed supra in respect of FIG. 5 the user 910 when registering with SINGLES AROUND ME™ 920 was able to identify multiple profiles that they had on both SINGLES AROUND ME™ 920 and the partners SOCNETAPs “Angel's” 930, “Dating Agency” 940, and “Cupid” 950. Accordingly the user 910 might be able to select from this list of multiple profiles which ones they wished to have displayed on display screen 980 when performing their searches.

It would be evident to one skilled in the art that the exemplary embodiment described supra in respect of FIG. 9 considers the results presented to user 910 on display screen 980 based upon three partner SOCNETAPs, namely “Angel's” 930, “Dating Agency” 940, and “Cupid” 950. However, due to the marketing or socio-demographic factors it might be that user 910 experiences or knows that for example “Dating Agency” 940 is typically associated with profiles of, for example, mature men and women seeking longer term relationships, than, for example, a younger age group on “Angel's” 930 who are more interested in seeking short term encounters. Accordingly it would be evident that the user 910 may within SINGLES AROUND ME™ 920 be able to establish a preference for searching particular partner SOCNETAPs when using their “FriendsFirst” profile to their “SuperStud” profile. Optionally, user 910 may wish to not receive profiles of other members on these partner SOCNETAPs who have multiple profiles, or who do have multiple profiles but exclude those matching one or more specific profiles, for example receive those who match “FriendsFirst” on the partner SOCNETAPs but exclude those who also have a match to “SuperStud”.

It would also be apparent to one skilled in the art that in the exemplary embodiments presented supra in respect of FIGS. 7 through 9 that users with multiple profiles have been presented wherein they have a common user profile name. This is possible with some SOCNETAPs today, such as LavaLife™, which allow a user to have the same profile name in different categories of their SOCNETAP, for example, “friends”, “relationship” and “intimate”, whilst others do not separate to the same degree and allow users to select multiple categories for one profile name, for example Adult Friend Finder™ Other SOCNETAPs do not permit a member to have a single profile with multiple categories but do allow a user to have multiple profiles, each one associated with a different category. Naturally, it is difficult for a user to know that these multiple profiles are associated with the same individual if they present different user names within a single SOCNETAP or multiple SOCNETAPs and different profiles, including images etc. Accordingly, a benefit to a user of a brokered SOCNETAP, such as SINGLES AROUND ME™, is the ability to identify such members when using the brokered SOCNETAP at a higher level, for example “Platinum” upon SINGLES AROUND ME™ as discussed supra.

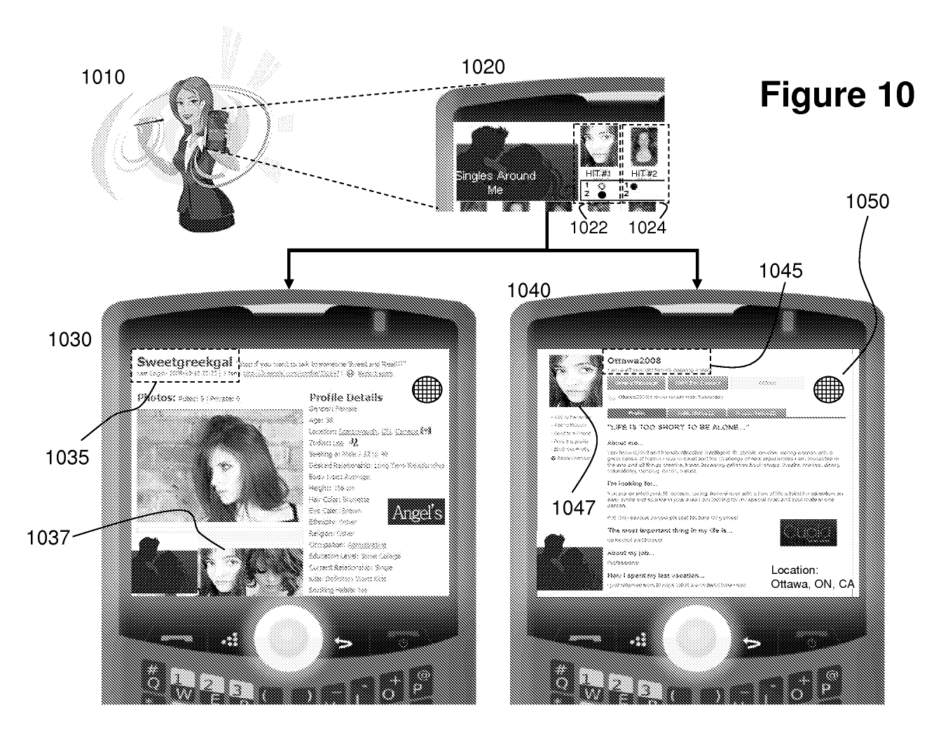

Accordingly, referring to FIG. 10 there is depicted an expansion of the information available to a user registered with a SOCNETAP according to an embodiment of the invention, such as a user having registered at a “Platinum” service level for SINGLES AROUND ME™ as presented supra in respect of FIG. 9, addressing this issue. As shown a user 1010 is accessing SINGLES AROUND ME™ (not shown for clarity) upon a wireless device 1020 which brokers content from multiple partner SOCNETAPs, such as discussed supra in respect of FIGS. 5 through 9. As shown the results of a search are displayed comprising “Hit #1” 1022 and “Hit #2” 1024, against the profile of the user 1010. “Hit 1022 is shown as having 2 profile “hits” that match the search and “Hit #2” has only 1 profile “hit”. If the user 1010 selects the first “hit” then they move to first screen 1030 wherein the profile of “SweetGreekGal” 1035 is presented to them as extracted from the website “Angel's”, for example “Angel's” 930 in FIG. 9 supra. This shows “SweetGreekGal” 1035 as being 38 years old and living in Scarborough, Ontario, Canada and amongst their public images is first image 1037.

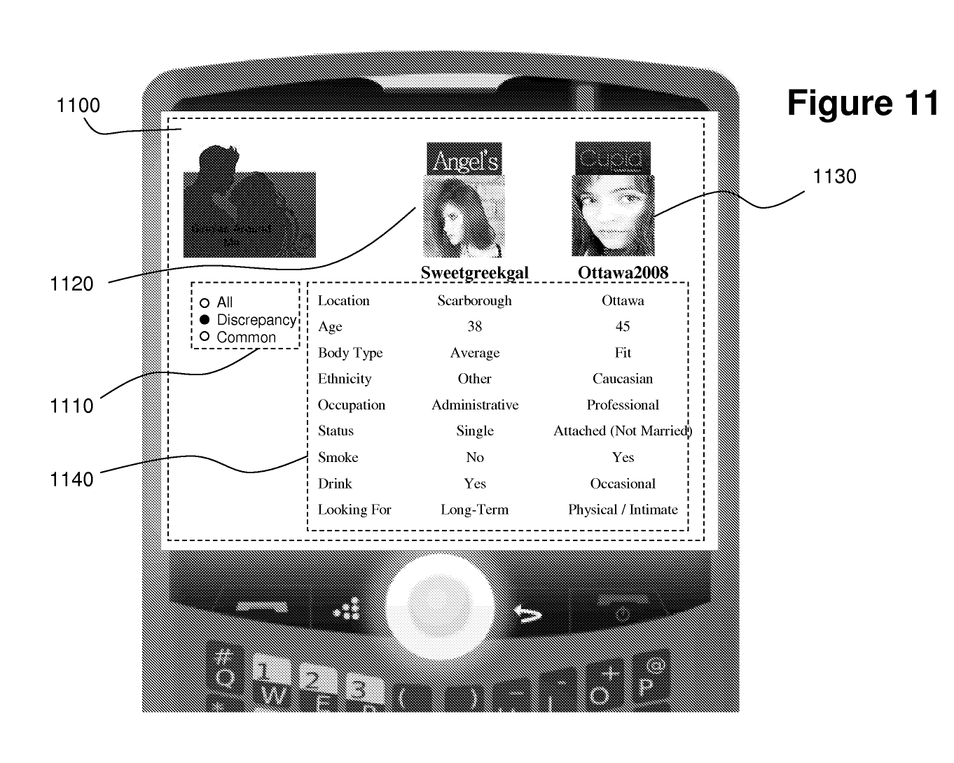

If the user 1010 selects the second “hit” then they move to second screen 1040 wherein the profile of “Ottawa2008” 1045 is presented to them as extracted from “Cupid”, for example “Cupid” 950 in FIG. 9 supra. This shows “Ottawa2008” 1045 as a 45 year old and living in Ottawa, Ontario, Canada and for their profile image is second image 1047. (Scarborough and Ottawa being towns approximately 350 km apart in Ontario, Canada). Accordingly the user 1010 can view individually the multiple profiles established by the individual who created “SweetGreekGal” 1035 and “Ottawa2008” 1045. Each of the first and second screens 1030 and 1040 respectively contain an icon 1050 which links to a further screen providing a comparison of the multiple profiles relating to a single individual. This screen will be described below in respect of FIG. 11.

It would be apparent to one skilled in the art that the SOCNETAP SINGLES AROUND ME™ establishes the relationship between “SweetGreekGal” 1035 and “Ottawa2008” 1045 using information provided by the individual creating them that is not presented to the user, although facial recognition of the images presented by registered members is possible the cross-referencing would be extremely cumbersome and time consuming. It might be more efficient for example to simply look for other occurrences of the email address provided in the registration process, such as provided when entering an email address in line 535 of FIG. 5 but as noted supra most SOCNETAPs according to the prior art limit any repeated use of an email address thereby limiting this approach. Matching may be performed with other data however, including for example a credit card number used to register for higher level services such as the “Premium” or “Platinum” selection in service level 546, a mobile device identifier such as mobile device number 541, or responses to security questions in combination with the security questions used to allow a registered member to recover entry to a SOCNETAP when they have forgotten their password or profile identity.

As described supra the user 1010 when viewing either first screen 1030 or second screen 1040 which relate to profiles for “SweetGreekGal” 1035 and “Ottawa2008” 1040 respectively can select an icon 1050 that transfers to screen 1100 as depicted in FIG. 11. Screen 1100 depicts an exemplary comparison of these multiple profiles associated with the same individual according to an embodiment of the invention at a premium level of service. Depicted on screen 1100 are the primary profile images of the individual from “Angel's” 1120 and “Cupid” 1130. Below these is table 1140 which lists different elements of the profiles together with the data extracted form the two profiles “SweetGreekGal” 1035 and “Cupid” 1045. Also shown is selector box 1110 which allows the user, not shown for clarity, to select how the data extracted from the profiles is presented. The options within selector box 1110 being “All”, “Discrepancy” and “Common”. Table 1140 being in this instance “Discrepancy”

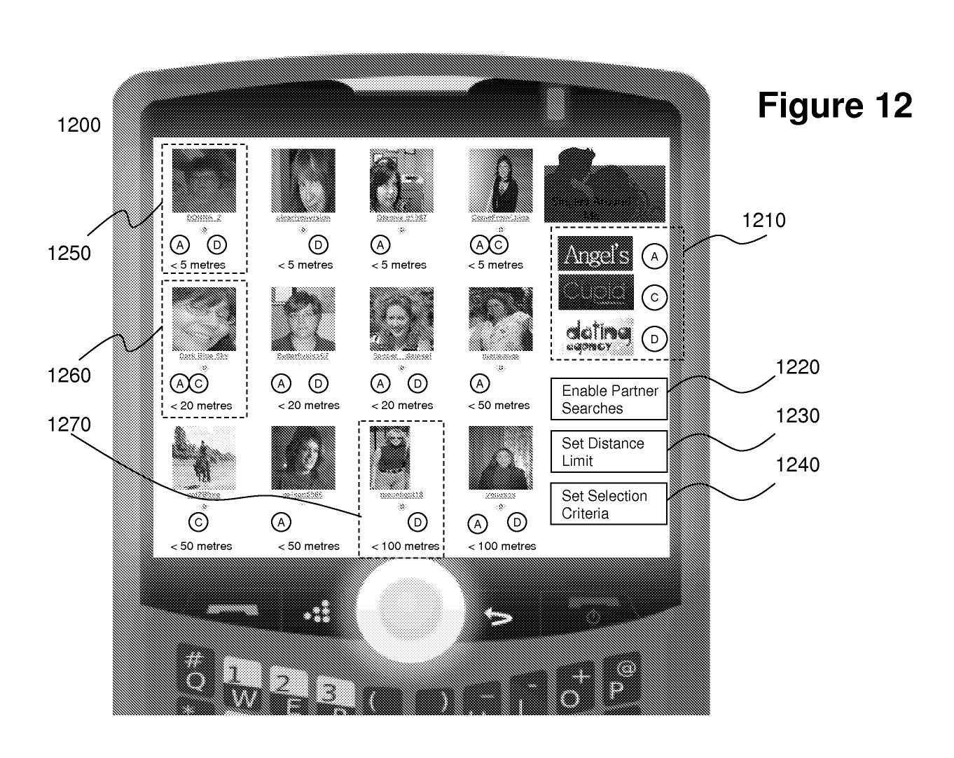

Now referring to FIG. 12 there is depicted an exemplary expansion of information based upon location information relative to a user for the user accessing a SOCNETAP according to an embodiment of the invention at a premium level of service. As described supra in respect of FIGS. 5 through 11 a user registered with a SOCNETAP such as SINGLES AROUND ME™ with a premium level of service, such as for example “Premium” and “Platinum” is able to browse and view profiles from multiple partner SOCNETAPs, such as “Angel's” 830, “Dating Agency” 840 and “Cupid” 850 as described supra in respect of FIG. 8. In FIG. 9 for example these partner SOCNETAPs provide the profiles presented to the user on display screen 980. However, in many instances the user accessing a SOCNETAP according to embodiments of this invention wishes to have their search results presented based upon distance from the user rather than closeness to matching a profile overall within a predetermined geographic radius, such as specified by distance 544 in FIG. 5 supra.

Accordingly in FIG. 12 there is depicted a mobile device 1200 upon which are shown the results of a profile search using SINGLES AROUND ME™. As shown there is partner box 1210 which lists the partner SOCNETAPs whose results are presented, these being “Angel's”, “Cupid”, and “Dating Agency” with identifiers “A”, “C”, and “D”. A fourth partner SOCNETAP, who would have been denoted by “B” is not shown as the user has de-selected them within a different screen for example. As described supra a user may elect to not include a particular SOCNETAP as there experience is that registered members of that SOCNETAP do not match their particular search criteria, or for some other reason. Also shown on mobile device 1200 is partner box 1220 that allows the user to move to the other screen described supra allowing them to enable or disable searching of specific partner SOCNETAPs. Distance box 1230 allows the user to set a distance limit for their searching, for example 100 meters, 2 kilometers, 25 kilometers etc. The distance limit for example may be set low when the user associated with the mobile device 1200, not shown for clarity, is for example within a downtown environment on a Friday evening seeking a partner for dinner.

The distance limit for example may be set high when the user associated with the mobile device 1200 is at home on a Sunday evening or at work during the week and seeking to browse a wide contact base. Also shown is selector box 1240 that links the user to another screen wherein the user may adjust selection criteria including for example which of their user profiles to use or a threshold for matching other profiles against their search criteria. Accordingly the results of the user search are shown upon the mobile device 1200 including “Donna_{—}2” 1250 who is shown as being within 5 meters of the user and has profiles on “Angel's” and “Dating Agency”. Also shown is “Dark Blue Sky” 1260 who is registered with “Angel's” and “Cupid” and is less than 20 meters away and “Moonlight” 1270 who is registered with “Dating Agency” and is less than 100 meters away.

It would be apparent to one skilled in the art that the distance determination of the users, such as “Donna_{—}2” 1250, “Dark Blue Sky” 1260, and “Moonlight” 1270, within SINGLES AROUND ME™ is unlike that of prior art applications wherein the determination of distances for members relative to the user searching are based upon the entry of information relating to their residence, work or other fixed location, this entry predominantly a postcode (zip code) associated with the user. It would also be apparent to one skilled in the art that the distance determination relative to the user may be established with one of many different approaches, the particular subset of approaches being dependent upon the distance range. For example, at distances of several kilometers to tens of kilometers it might be sufficient to determine which cell tower a mobile device associated with each user is within. At a distance of a kilometer or so determination within coverage of a cell tower may be employed using triangulation, power or timing for example. Distances of meters may for example be determined by triangulation from multiple femtocells within an urban environment. Alternatively, wherein the mobile device is equipped with a Global Positioning System (GPS) interface then the location of the user may be established by interrogating the mobile device and retrieving its location. Normal GPS accuracy being approximately 20 meters.

It would also be apparent to one skilled in the art that updating the distance indications to the user of the mobile device 1200 may be performed on time bases that are established either by preset parameters within the SOCNETAP or established by the user of the mobile device 1200. For example preset parameters may include increasing the frequency of updating as determined separation decreases or increasing the frequency at particular times of day, such as for example between 1 pm and 2 pm representing lunchtime and between 5 pm and 11 pm representing the major time when users may be dining out in restaurants, being in nightclubs, at home browsing, etc. Beneficially, adjusting the frequency of location updates based upon such presets reduces the requirements of the user's mobile device to transmit it's location to SINGLES AROUND ME over the wireless network, which if performed at high frequency represents a significant overall data usage per month for the user within a mobile device plan with a carrier that has high penalties for exceeding a preset limit or is expensive to give unlimited usage.

Optionally, the SINGLES AROUND ME™ application may establish the frequency with which updating of location information is undertaken dynamically based upon actions of the user, for example the user may be shown updates of profiles every 5 minutes but if they request a real-time update of a particular user is requested to pay an additional fee and the target members mobile device is set to transmit position every 10 seconds for example, a portion of the additional fee may potentially go direct to the target members account to offset their increased mobile data usage.

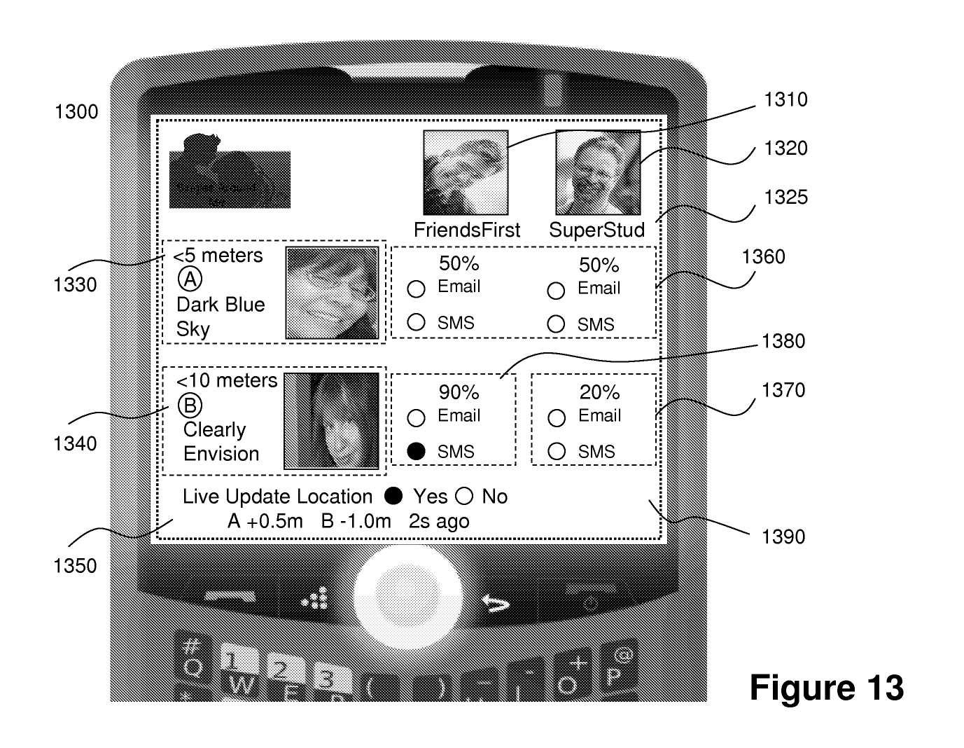

Now referring to FIG. 13, there is a display screen 1390 for a user, not shown for clarity, accessing a SOCNETAP according to an embodiment of the invention, such as SINGLES AROUND ME™ for example at a premium level of service wherein the user is presented with matches against their multiple profiles and options to contact them. Accordingly, display screen 1390 upon a mobile device 1300 shows two user profiles associated with the user of the mobile device 1300, these being “FriendsFirst” 1310 and “SuperStud” 1320 as well as two member profiles that the user has selected which represent people the user is interested in meeting immediately having determined that they are within close proximity to them. These being “Dark Blue Eyes” 1330 and “Clearly Envision” 1340, where for each in addition to a profile image and their profile name there is an indication of distance from the user, namely less than 5 meters and less than 10 meters respectively. Also shown on the display 1390 against “Dark Blue Eyes” 1330 is first match matrix 1360 wherein there is displayed a percentage match of the member profile of “Dark Blue Eyes” 1330 against the profiles of “FriendsFirst” 1310 and “SuperStud” 1320 which are shown at 50% in each instance. Also for each of “FriendsFirst” 1310 and “SuperStud” 1320 there are icons representing “Email” and “SMS” (Short Message Service) which allow the user to contact “Dark Blue Eyes” 1330 with either of these methods with a message indicating that they are either “FriendsFirst” 1310 and “SuperStud” 1320.

Similarly, “Clearly Envision” 1340 has second match matrix 1380 and third match matrix 1390 associated with themselves and the user profiles of “FriendsFirst” 1310 and “SuperStud” 1320. Again each of the second match matrix 1380 and third match matrix 1370 contain the icons representing “Email” and “SMS” together with the matching percentage of the respective profiles which are 90% and 20% respectively in this case for “FriendsFirst” 1310 and “SuperStud” 1320. Also displayed is an option 1350 for the user to enable or disable a live update of location, which is shown as enabled and presents the information text “A +0.5 m B −1.0 m 2 s ago”. This telling the user that “Dark Blue Eyes” 1330 had moved further away by 0.5 m, “Clearly Envision” had moved closer by 1.0 m and the last position update was 2 seconds ago. Accordingly, our user is aware that “Clearly Envision” 1330 who has a very high match percentage to their “FriendsFirst” 1310 profile is very close and getting closer and has selected “SMS” to contact them. In a subsequent screen or pop-up within the current display screen 1360 the user would then be able to enter a quick text message to “Clearly Envision” 1330 that would be sent to their mobile device via SINGLES AROUND ME™ indicating that “FriendsFirst” 1310 was nearby and wished to meet them.

It would be evident to one skilled in the art that the user registered with a brokering SOCNETAP not only has increased information available to them in respect of the number of members, that members have multiple profiles but also in respect of having this increased information presented to them in a manner that is user friendly and where necessary is updated in real time, such as location information.

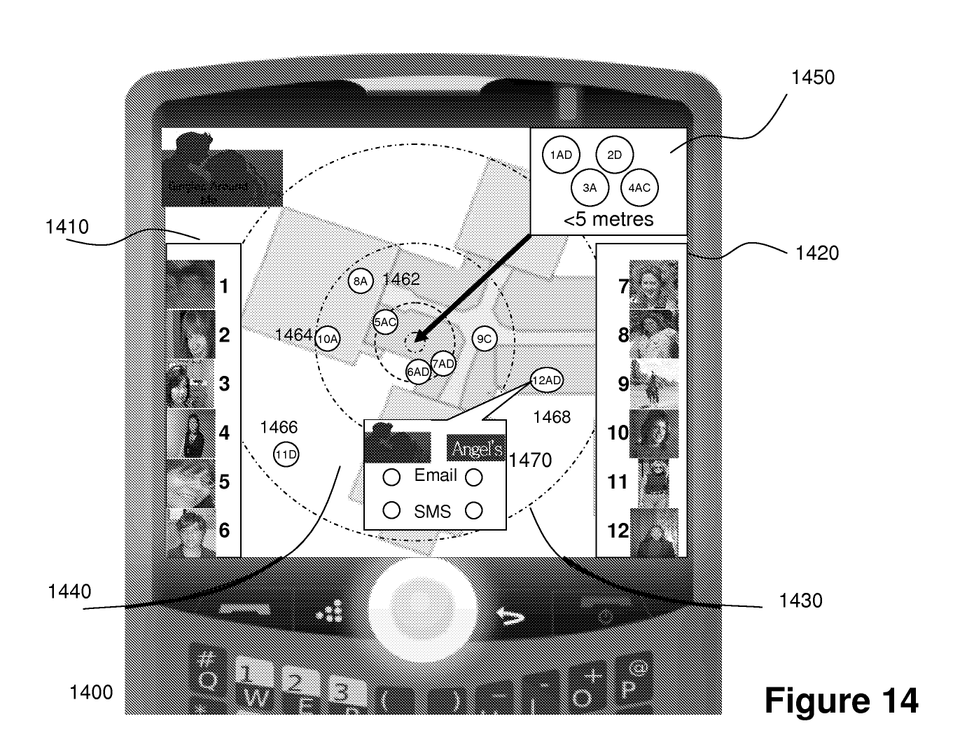

Referring to FIG. 14 there is depicted an exemplary expansion of information presenting matching users geographically relative to a user for the user accessing a SOCNETAP according to an embodiment of the invention, such as SINGLES AROUND ME™, at a premium level of service. As such a user, not shown for clarity, has selected the SOCNETAP application SINGLES AROUND ME™ upon their mobile device 1400 and performed a profile search; essentially identical to that they performed to obtain the results displayed upon their mobile device within FIG. 12 supra. However, the user has selected an alternate display option and is presented with local geographic information 1440 upon which are presented the search results. Examples of sources for such geographic information 1440 being for example Yahoo™, Google™, and Bing™, and may be schematic or satellite derived. As such the user is presented with first profile bar 1410 which displays profile images for users returned in the search results, these being numbered 1-6, and second profile bar 1420 which similarly displays profile images and are numbered 7-12.

Superimposed onto the geographical information 1440 are distance radii 1430 which for example are set at 5 meters, 20 meters, 50 meters, and 100 meters. Display box 1450 shows that members 1, 2, 3, 4 are within 5 meters and also that they have profiles upon multiple partner SOCNETAPs, indicated for example by “1AD” and “4AC”. Other members for example “8” 1462, “10” 1464, “11” 1466 and “12” 1468 are also displayed upon the geographic information 1440. The user in this case has selected member “12” 1468 either by this icon on the map or their image within second profile bar 1420 resulting in pop-up 1470 appearing that shows that member “12” is registered with SINGLES AROUND ME™, the “A” within their icon, and “Angel's”, the “D” within their icon. Pop-up 1470 providing the option for the user to contact this member by either “Email” or “SMS” via either their SINGLES AROUND ME or “Angel's” profiles.

It would be apparent that the presentation of the location information within a geographical context allows the user to contact a member with a more specific message that would be possible using the prior art SOCNETAPs where location information is derived from static points, i.e. a postcode or zip code. For example referring to FIG. 12 above the user can message the member saying that they would like to meet them at a coffee shop within the Food Court at the Mall they are both currently within. Alternatively, the user in another scenario, not presented visually, would see that whilst the user they wish to meet is say only 20 meters away, that between them there is a river running through the downtown core they are currently within and that there are no bridges either way for several hundred meters. Hence, they can adjust their message to this information increasing potentially the impression they make on the other member.

Within the embodiments described supra in respect of FIGS. 5 through 14 the embodiments of the invention described therein have been primarily addressing the extraction of member profiles for use by a user who has registered with SINGLES AROUND ME™ with one of the different levels of service. As described supra in respect of FIG. 5 a user may enter within third entry screen 550 any user profiles that they have upon partner SOCNETAPs, such as for example first partner SOCNETAP “Cupid” 542, second partner SOCNETAP “Dating Agency” 543 and third partner “Angel's Dating” 544. In addition to providing functions including for example searching profiles, selecting presentation formats, and analysis/contact options it would be beneficial if the brokering SOCNETAP, such as SINGLES AROUND ME™, allowed the user to manage their profiles on the partner SOCNETAPs without requiring them to log-in and manage them directly within each partner SOCNETAP.

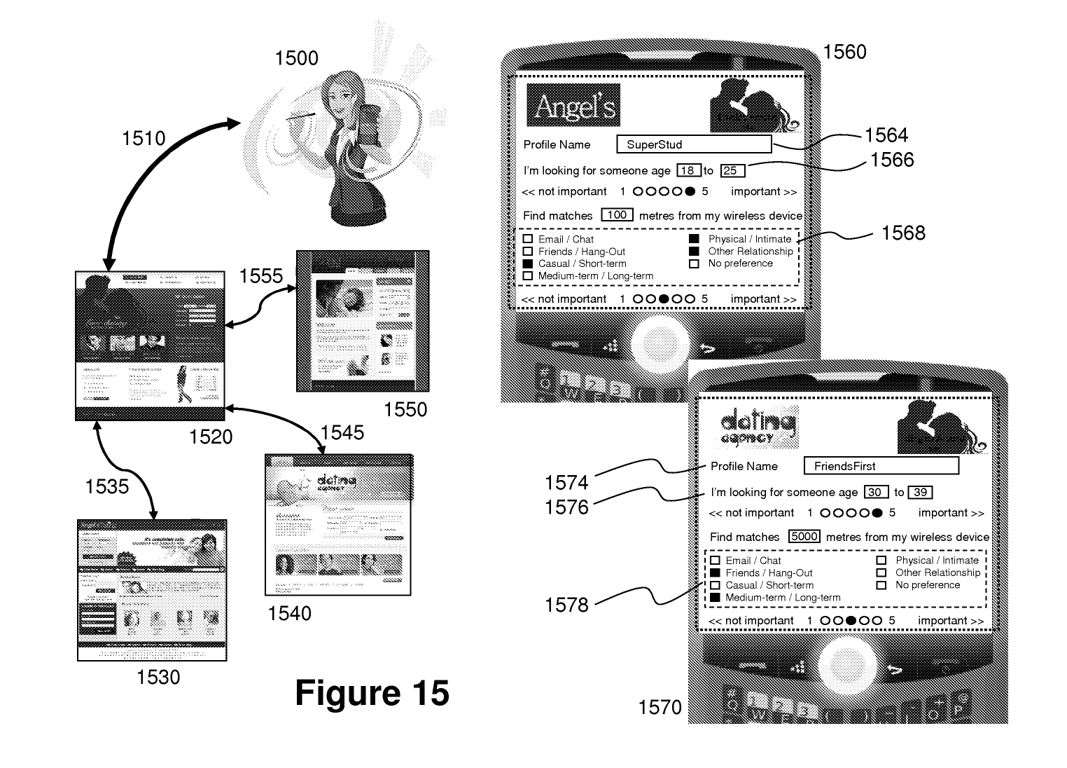

As such FIG. 15 depicts an exemplary information flow for a user accessing a SOCNETAP according to an embodiment of the invention with a premium level of service and managing their user profiles on partner SOCNETAP databases. As shown user 1500 interacts with the SOCNETAP SINGLES AROUND ME™ 1520 through a wireless device and first information flow 1510. SINGLES AROUND ME™ 1520 then parsing the first information flow 1510 as necessary to communicate with the partner SOCNETAPs, these being first partner “Cupid” 1530 through second information flow 1535, second partner SOCNETAP “Dating Agency” 1540 through third information flow 1545, and third partner “Angel's Dating” 1550 through fourth information flow 1555. Selecting an option within the tools provided by SINGLES AROUND ME™ 1520 the user decides to change an aspect of their profile “SuperStud” which is hosted by third partner “Angel's” 1550.

As shown with first mobile screen 1560 the user is presented with their profile information for “SuperStud” 1564 which includes their first age preference 1566, being 18-25, and first categories 1568, being “Casual/Short-Term”, “Physical/Intimate” and Other Relationship”. The user is able to change this information, and other profile information stored by “Angel's” 1550 through SINGLES AROUND ME™ 1520 in a series of screens according to the prior art presented in respect of FIG. 2 for example. Similarly the user decides to adjust an aspect of their profile “FriendsFirst” which is hosted by second partner SOCNETAP “Dating Agency” 1540. As such the user is shown second mobile screen 1570 and their profile information for “FriendsFirst” 1574 which includes their second age preference 1576, being 30-39, and second categories 1578, being “Friends/HangOut” and “Medium-Term/Short-Term”.

Accordingly, it would be evident to one skilled in the art that the user may dynamically manage their profiles upon the partner SOCNETAPs through the SINGLES AROUND ME™ SOCNETAP according to an embodiment of the invention. Optionally, the user may opt to perform this adjustment during any of the other search, display, contact options associated with a brokering SOCNETAP such as disclosed supra in respect of FIGS. 5 through 14. The user may therefore optionally adjust the profile to increase a percentage overlap with an individual who is within their vicinity prior to contacting the other member, wherein if the member receives a message with an indication from their SOCNETAP that the user wishes to contact them and has a percentage match of X % this can be increased to increase the likelihood that the member replies.

It would be evident to one skilled in the art that the above embodiments presented supra in respect of FIGS. 5 through 15 may be adjusted according to a status of for example the mobile device that the user is accessing the brokering SOCNETAP, for example SINGLES AROUND ME™, via. Accordingly requests from the mobile device to the brokering SOCNETAP may contain status information including for example, an indication of battery status, an indication of whether the device is interfaced to a power source other than the internal battery, an indication of quality of wireless reception, an indication of data rate of communications with the network, and an indication of whether GPS location can be performed. Such status information being exploited by the brokering SOCNETAP to adjust the content provided to the mobile device, i.e. reducing graphic content when quality or data rate are poor/slow, or removing options such as geographic searching when GPS location is not possible. Alternatively, the brokering SOCNETAP may interface with the service provider for the mobile device associated with the user and retrieve information such as their wireless plan, remaining minutes, data transferred to date etc allowing a similar optimization of content to minimize wireless service costs to the user.

It would be evident that the embodiments described supra in respect of a brokering service, such as SINGLES AROUND ME™, and the partner services applies equally to each partner service which act as a brokering service to its own registered members. Accordingly, all members of any service within a partnership access all the other services. Similarly, revenue apportioning is performed by each brokering service. Overall a reconciliation process would probably be performed rather than every partner service paying every other service and then receiving monies back from that partner service for the reciprocal activities.

It would be apparent that whilst the above embodiments have been presented in some aspects with respect to providing a dating or matchmaking type service the invention may be employed in a variety of other applications. Examples of such applications include conferences, tradeshows, tours, cruises, etc.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
(a) providing a brokering service, the brokering service being accessible through the Internet and relating to an activity;
(b) receiving at the brokering service a request from a user, the request being associated with an aspect of the activity;
(c) retrieving from a predetermined subset of a plurality of databases information stored within the predetermined subset of databases, the retrieved information determined in dependence upon at least the request, each database of the plurality of databases being associated with a database source comprising at least one of the brokering service and at least one partner service of a plurality of partner services partnered with the brokering service;
(d) processing the retrieved data in dependence upon an indicator to generate presentation data;
(e) presenting the presentation data to the user;
(f) determining whether a service fee is payable to the database source of at least one partner service of the plurality of partner services, the determination being made in dependence upon at least the request; and
(g) where a service fee is payable to at least one partner service of the plurality of partner services storing an indication of the magnitude of the service fee within a fee database for subsequent use in paying the service fee.

2. A method according to claim 1 wherein;
the predetermined subset of the plurality of databases is at least one of a database associated with the brokering service, a database associated with the brokering service and databases associated with a predetermined portion of the plurality of partner services, and all databases associated with the brokering service and the plurality of partner services.

3. A method according to claim 1 wherein,
the service fee is determined in dependence upon a ratio of the retrieved information retrieved from the one partner service of the plurality of partner services to the total retrieved information.

4. A method according to claim 1 wherein,
the service fee is subsequently adjusted, the adjustment being determined in dependence upon an action of the user upon presentation of the presentation information to the user.

5. A method according to claim 1 wherein,
the activity relates to at least one of identifying occurrences of information within the brokering service and the plurality of partner services that match to a predetermined level information relating to the user.

6. A method according to claim 5 wherein,
the information relating to the user is stored within a database associated with at least one of the brokering service, a predetermined partner service of the plurality of partner services, and a mobile device associated with the user.

7. A method according to claim 5 wherein,
the information relating to the user comprises one set of profile information of a plurality of sets of profile information, each one of the sets of profile information of the plurality of sets of profile information being stored within a database associated with at least one of the brokering service, a partner service of the plurality of partner services, and a mobile device associated with the user.

8. A method according to claim 1 wherein,
determining the retrieved information includes determining the information based upon at least one of a service level of the user with the brokering service, a range, the range being the separation between a current location of the user and a last known location of a member registered with at least one of the brokering service and a partner service of the plurality of partner services, the member having information stored within at least one of the brokering service and the partner service of the plurality of partner services that matches information relating to the user to a predetermined degree and includes the last known location.

9. A method according to claim 1 wherein,
determining the retrieved information comprises;
firstly retrieving the information relating to members having information stored within at least one of the brokering service and the partner service of the plurality of partner services that matches information relating to the user to a predetermined degree;
establishing a location for each member whose information is retrieved;
storing the location as the last known location of the member whose information is retrieved; and
filtering the retrieved information to remove members whose information is retrieved where their separation from the user as determined by their last known location exceeds a predetermined value.

10. A method according to claim 1 wherein,
determining the retrieved information comprises retrieving the information relating to members having information stored within at least one of the brokering service and the partner service of the plurality of partner services that matches at least one set of information of a plurality of sets of information relating to the user to a predetermined degree.

11. A method according to claim 10 wherein,
each set of information of the plurality of sets of information relating to the user is stored within at least one of a database associated with the brokering service, a database associated with a partner service of the plurality of partner services, and a mobile device associated with the user.

12. A method according to claim 1 wherein,
processing the retrieved information comprises at least one of filtering the retrieved information, adjusting an image within the retrieved information to reduce the amount of data required to transmit the image, encoding the retrieved information, formatting the retrieved information, and deleting repeated retrieved information.

13. A method according to claim 1 wherein,
processing the retrieved information comprises at least one of associating, highlighting, merging, and deleting retrieved information having a common entry within a predetermined field of information stored within the database associated with at least one of the brokering service and the plurality of partner services.

14. A method according to claim 13 wherein,
the predetermined field of information relates to at least one of a name of an individual, a telephone number, a mobile device identifier, an electronic mail address, a credit card number and a social security number.

15. A method according to claim 1 wherein,
the indicator relates to at least one of a quality of wireless service for a mobile device associated with the user, a measure of service plan for a mobile device associated with the user, an aspect relating to a mobile device associated with the user, and the presence of multiple profiles relating to a single individual.

16. A method according to claim 1 further comprising:
(h) waiting a predetermined period of time;
(i) repeating steps (c), (d), and (e).

17. A method according to claim 1 further comprising:
(h) waiting a predetermined period of time;
(i) establishing a new current location for the user;
(j) establishing a new location for each individual of a plurality of individuals for whom information was retrieved in step (c);
(k) updating the presentation data to include at least one of the new location for each individual or a plurality of new ranges, each new range of the plurality of new ranges being determined in dependence upon at least the new current location of the user and the new location of an individual of the plurality of individuals.

18. A method according to claim 17 wherein,
steps (h), (i), (j), (k) are performed at least one of upon receipt of a new request from at least one of the user and a mobile device associated with the user, automatically by the brokering service based upon the activity of the user with the brokering service, in dependence upon the time of day, and in dependence upon a minimum separation between the user and an individual of the plurality of individuals meeting a predetermined value.

19. A method according to claim 1 further comprising:
(l) receiving from the user a second request, the second request relating to a request to contact an individual of a plurality of individuals for whom information was retrieved in step (c);
(m) generating a contact message from the user to the individual of the plurality of individuals, the contact message being generated in dependence upon at least one of an identity of the user within at least one of the brokering service and a partner service of the plurality of partner services, the one of the brokering service and a partner service of the plurality of partner services associated with the individual of the plurality of individuals, the one of the brokering service and a partner service of the plurality of partner services associated with the user, and content received from the user; and
(n) transmitting the contact message to the individual of the plurality of individuals.

20. A method according to claim 19 wherein,
step (n) comprises sending the contact message at least one of to the partner service of the plurality of partner services, an electronic address, and a mobile device associated with the individual of the plurality of individuals.

21. A method comprising:
(a) providing a brokering service, the brokering service being accessible through the Internet and relating to an activity;
(b) receiving at the brokering service a request from a user, the request being associated with an aspect of the activity;
(c) retrieving from a predetermined subset of a plurality of databases information stored within the predetermined subset of databases and determined in dependence upon at least the request, each database of the plurality of databases being associated with a database source comprising at least one of the brokering service and at least one partner service of a plurality of partner services partnered with the brokering service;
(d) filtering the retrieved data in dependence upon a measure of distance between the user and the last known current location of each individual of a plurality of individuals associated with a predetermined portion of the retrieved data;
(e) processing the filtered retrieved data in dependence upon an indicator to generated presentation data;
(f) presenting the presentation data to the user;
(g) determining whether a service fee is payable to the database source of at least one partner service, the determination being made in dependence upon at least the request;
(h) where a service fee is payable to the at least one partner service storing an indication of the magnitude of the service fee within a fee database for subsequent use in paying the service fee;
(i) waiting a predetermined period of time;
(j) establishing a new current location for the user;
(k) establishing a new location for each individual of a plurality of individuals for whom information was retrieved in step (c);
(l) updating the presentation data to include at least one of the new location for each individual or a plurality of new ranges, each new range of the plurality of new ranges being determined in dependence upon at least the new current location of the user and the new location of an individual of the plurality of individuals.
